(19) United States
(12) Patent Application Publication
(10) Pub. No.: US 2018/0246314 A1
(43) Pub. Date: Aug. 30, 2018

(54) TUNABLE MICROLENSES AND RELATED METHODS

(71) Applicant: Massachusetts Institute of Technology, Cambridge, MA (US)

(72) Inventors: Timothy M. Swager, Newton, MA (US); Lauren Dell Zarzar, State College, PA (US); Sara N. Nagelberg, Somerville, MA (US); Mathias Kolle, Hull, MA (US)

(73) Assignee: Massachusetts Institute of Technology, Cambridge, MA (US)

(21) Appl. No.: 15/887,863

(22) Filed: Feb. 2, 2018

Related U.S. Application Data
(60) Provisional application No. 62/454,663, filed on Feb. 3, 2017.

(51) Int. Cl. G02B 26/00

(52) U.S. Cl. CPC G02B 26/004

(57) ABSTRACT

Embodiments described herein may be useful for optofluidic devices. For example, optofluidic devices using dynamic fluid lens materials represent an ideal platform to create versatile, reconfigurable, refractive optical components. For example, the articles described herein may be useful as fluidic tunable compound micro-lenses. Such compound micro-lenses may be composed of two or more components (e.g., two or more inner phases) that form stable bi-phase emulsion droplets in outer phases (e.g., aqueous media). Advantageously, the refractive index contrast at each material interface and/or the curvature of each interface may contribute to the focusing power of a refractive optical element, allowing for a wide tuning range of the emulsion lenses' focal length, and thereby enabling switching between converging or diverging lens geometries. Advantageously, the radius of curvature between two or more components and/or the average focal length of transmitted or reflected light through the droplets may be controlled by exposing the plurality of droplets to a stimulus.

### RELATED APPLICATIONS

This application claims priority under 35 U.S.C. § 119(e) to co-pending U.S. Provisional Application Ser. No. 62/454,663, filed Feb. 3, 2017, entitled “Tunable Microlenses And Related Methods”, which is incorporated herein by reference in its entirety for all purposes.

### GOVERNMENT SUPPORT

This invention was made with Government support under Grant No. DMR-1533985 awarded by the National Science Foundation, and Grant No. W911NF-13-D-0001 awarded by the Army Research Office. The Government has certain rights in the invention.

### FIELD OF THE INVENTION

The present invention generally relates to tunable microlenses and related methods.

### BACKGROUND

Emulsification is a powerful age-old technique for mixing and dispersing immiscible inner phases within a continuous liquid phase. Consequently, emulsions are central components of medicine, food, and performance materials. Complex emulsions, including multiple emulsions and Janus droplets, are of increasing importance in pharmaceuticals and medical diagnostics, in the fabrication of microdroplets and capsules for food, in chemical separations, for cosmetics, and for performance materials like paints and coatings. As complex emulsion properties and functions are generally related to droplet geometry and composition, the development of rapid and facile fabrication approaches allowing precise control over the droplets' physical and chemical characteristics is critical. Significant advances in the fabrication of complex emulsions have been accomplished by a number of procedures, ranging from large-scale less precise techniques that give compositional heterogeneity using high-shear mixers and membranes to small-volume microfluidic methods. However, such approaches have yet to create droplet morphologies that can be controllably altered after emulsification.

### SUMMARY OF THE INVENTION

The present invention provides tunable microlenses and related methods.

In one aspect, articles are provided. In some embodiments, the article comprises a plurality of droplets dispersed within an outer phase, wherein the plurality of droplets comprise a first component and a second component immiscible with the first component under a particular set of conditions, at least a first portion of the plurality of droplets has a first average focal length for transmitted or reflected light, and at least a second portion of the plurality of droplets has a second average focal length for transmitted or reflected light, different than the first average focal length.

In some embodiments, the article comprises a plurality of droplets dispersed within an outer phase, wherein the plurality of droplets comprise a first component and a second component immiscible with the first component under a particular set of conditions, at least a first portion of the plurality of droplets has a first radius of curvature between the first component and the second component that causes light rays to focus, and at least a second portion of the plurality of droplets has a second radius of curvature between the first component and the second component that causes light rays to focus, different than the first radius of curvature.

In some embodiments, the article comprises a plurality of droplets dispersed within an outer phase, wherein the plurality of droplets comprise a first component and a second component immiscible with the first component under a first set of conditions, the plurality of droplets have a first average focal length for transmitted or reflected light under the first set of conditions, and the plurality of droplets have a second average focal length for transmitted or reflected light different than the first average focal length under a second set of conditions, different than the first set of conditions.

In some embodiments, the article comprises a plurality of droplets dispersed within an outer phase, wherein the plurality of droplets comprise a first component and a second component immiscible with the first component under a first set of conditions, the plurality of droplets have a first average radius of curvature between the first component and the second component that causes light rays to focus under the first set of conditions, and the plurality of droplets have a second average radius of curvature between the first component and the second component that causes light rays to focus under a second set of conditions, different than the first set of conditions.

In another aspect, methods are provided. In some embodiments, the method comprises providing a plurality of droplets dispersed within an outer phase, wherein the plurality of droplets have a first average radius of curvature between a first component and a second component within the droplets and stimulating the plurality of droplets such that at least a portion of the plurality of droplets has a second average radius of curvature between the first component and the second component, different than the first average radius of curvature.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

FIGS. 1A-D are schematic drawings illustrating an article comprising a plurality of droplets, according to one set of embodiments.

FIGS. 1E-1F are schematic drawings illustrating the focal length of transmitted light through exemplary droplet configurations, according to one set of embodiments.

FIGS. 1G-1H are schematic drawings illustrating an article comprising a plurality of droplets, according to one set of embodiments.

FIG. 2A is a schematic of the effect of interfacial tensions on the configuration of a droplet where encapsulation of a fluorocarbon (F) by a hydrocarbon (H) in water (W) is favored, according to one set of embodiments.

FIG. 2B is a schematic of the effect of interfacial tensions on the configuration of a droplet where the formation of a Janus droplet of a fluorocarbon (F) and a hydrocarbon (H) in water (W) is favored, according to one set of embodiments.

FIG. 2C is a schematic of the effect of interfacial tensions on the configuration of a droplet where encapsulation of a hydrocarbon (H) by a fluorocarbon (F) in water (W) is favored, according to one set of embodiments.

FIG. 3A is a schematic of the geometry of a two component droplet, according to one set of embodiments.

FIG. 3B is a schematic of switching between focusing and diverging geometries, according to one set of embodiments.

FIG. 3C is a side view optical micrograph of exemplary droplets composed of FC-770 and heptane with varying internal interface curvature, according to one set of embodiments.

FIG. 3D shows corresponding ray tracing simulations showing the propagation of light rays through the droplets, according to one set of embodiments.

FIG. 4A is a schematic of the setup used to record the light field behind the droplets, according to one set of embodiments.

FIG. 4B are iso-surfaces of the reconstructed light fields behind the droplets for different internal droplet morphologies, according to one set of embodiments.

FIG. 5A is a schematic of the optical setup used for focal length and image forming analysis. A grid image was projected in front of the droplets to serve as the object for the micro-lenses. The image formed by the droplets was recorded using a 10× objective, according to one set of embodiments.

FIG. 5B is a plot of the effective focal length as a function of internal radius of curvature Rᵢ, normalized by the droplet diameter R_{d}, according to one set of embodiments.

FIG. 5C is a plot of the numerical aperture NA as a function of internal radius of curvature Rᵢ given by

$$N A ( {R}_{i} ) = n sin ( {tan}^{- 1} \frac{{R}_{d}}{f ( {R}_{i} )} ) ,$$

according to one set of embodiments.

FIG. 5D is a plot of the point spread function estimate (PSF) of droplets with a numerical aperture NA=0.12 for red light, according to one set of embodiments.

FIG. 5E is a plot of the modulation transfer function (MTF) for the same droplets in FIG. 5D, according to one set of embodiments.

FIGS. 6A-6C are 2D Finite Difference Time Domain simulations of droplets of 5 μm radius for incident light of 500 nm wavelength. The internal radii of curvature are 4 μm (FIG. 6A), 9 μm (FIG. 6B), and infinite (FIG. 6C), according to one set of embodiments.

FIG. 6D is an image of localized exposure of droplets including light-sensitive surfactants to UV light, according to one set of embodiments.

FIG. 6E is a schematic illustration showing two different geometries for observing the photo-patterned droplet films, corresponding to the perceived images shown in FIGS. 6F-6G, according to one set of embodiments.

FIGS. 6F-6G are images of photo-patterned droplets viewed from above (FIG. 6F) and at an angle (FIG. 6G), according to one set of embodiments.

FIG. 6H is a schematic diagram of tomographic imaging of micro-scale objects in a microfluidic system using the fluid compound lenses, according to one set of embodiments.

FIG. 6I is a photograph of a monolayer array of fluid compound lenses, according to one set of embodiments.

FIG. 6J is a photograph of images projected by the monolayer lenses, according to one set of embodiments.

FIG. 7 is schematic diagram of the geometry of an exemplary droplet, according to one set of embodiments.

FIG. 8A is a schematic diagram of the determination of the focal length relative to an image location, according to one set of embodiments.

FIG. 8B is an exemplary plot of image location used to determine focal length, according to one set of embodiments.

FIG. 9A is a schematic of ray-tracing diagrams for droplets with volume ratios of hydro- to fluorocarbon V_H/V_F=0.5, 1, and 2, where the contact angle measured from the hydrocarbon-fluorocarbon interface to the fluorocarbon-water interface is kept constant at θ_F=π/4, according to one set of embodiments.

FIG. 9B a plot of the effective focal length in units of droplet radius f_eff/R_d plotted against volume ratio V_H/V_F, for contact angles θ_F of 0.1, π/6, and π/4, according to one set of embodiments.

FIG. 10 is a schematic diagram of the location of the image inside of a droplet using the Paraxial Approximation, according to one set of embodiments.

FIG. 11A is a schematic of the Geogebra model used to determine the apparent height of an object located inside a droplet of refractive index n=1.39, according to one set of embodiments.

FIG. 11B is a plot of the magnification of the object located inside of the droplet (open circles) and difference in position between object and image Δx (closed circles), according to one set of embodiments.

FIGS. 12A-12B are photographs of the variation of droplet morphology composed of heptane and FC770 over time, if diffusion of heptane is not suppressed (FIG. 12A) and where droplet morphologies are stable, if diffusion of heptane is suppressed by enclosing the system and priming the aqueous medium with heptane (FIG. 12B), according to one set of embodiments.

FIG. 13A is a photograph of an array of uniform emulsion droplet lenses, according to one set of embodiments.

FIG. 13B is a plot of the point spread functions (PSF) of the droplets shown in (FIG. 13A), according to one set of embodiments.

FIG. 13C is a plot of the fit to the Airy disk, according to one set of embodiments.

FIG. 13D is a plot of the distribution of the minimum in the Airy pattern, which generally correlates with the Rayleigh two-point resolution limit, according to one set of embodiments.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

Embodiments described herein may be useful for optofluidic devices. For example, optofluidic devices using dynamic fluid lens materials represent an ideal platform to create versatile, reconfigurable, refractive optical components. For example, the articles described herein may be useful as fluidic tunable compound micro-lenses. Such compound micro-lenses may be composed of two or more components (e.g., two or more inner phases) that form stable bi-phase (or multi-phase) emulsion droplets in outer phases (e.g., aqueous media). Advantageously, the refractive index contrast at each material interface and/or the curvature of each interface may contribute to the focusing power of a refractive optical element, allowing for a wide tuning range of the emulsion lenses' focal length, and thereby enabling switching between converging or diverging lens geometries. In some embodiments, the droplet-based lenses can be easily fabricated on a large scale using, for example, a temperature-induced phase separation technique. Advantageously, the radius of curvature between two or more components and/or the average focal length of transmitted or reflected light through the droplets may be controlled by exposing the plurality of droplets to a stimulus.

The articles described herein may be useful, for example, in adaptive light field imaging, integral imaging, 3D displays, responsive illumination shaping, bio-sensing via optical transduction mechanisms (e.g., for label-free detection assays for proteins or small molecules), light harvesting in solar energy conversion systems (e.g., such as autonomous sun-position trackers that optimize light-intake on the absorption element that converts photons into electrons), alternatives to mechanical focusing of optical systems (e.g., microlenses with controllable focal lengths may reduce or eliminate the need for mechanically moving parts and/or reduce the size of optical systems while enabling high precision focusing), medical imaging (e.g., ophthalmology, endoscopy), optical sensing, advanced biocompatible photolithography, optical trapping, and laser optics.

Articles comprising a plurality of droplets (e.g., colloids) as described herein offer numerous advantages to such articles known in the art, including the ability to reversibly, dynamically, and/or controllably change the focal length for transmitted or reflected light (e.g., in response to exposure to a stimulus). In some embodiments, the article comprises an outer phase and a plurality of droplets comprising two or more components. For example, in certain embodiments, the article comprises an outer phase and a plurality of droplets comprising a first component and a second component. Additional components (e.g., a third component, a fourth component) are also possible. Those skilled in the art will also be capable of selecting suitable materials and/or components for use in the embodiments described herein based on the teachings of the specification and examples below.

In some embodiments, the article may be stimulated (e.g., by a first stimulus such as a change in temperature or exposure to an analyte) such that the average radius of curvature between two components and/or the average focal length for transmitted or reflected light of at least a portion of the plurality of droplets change. Those skilled in the art would understand that changes in radius of curvature as described herein does not refer to the motion of immiscible components in a droplet due to regular fluid motion driven by passive diffusion and/or Brownian motion, but instead refer to the controlled change in the configuration of the components as a result of the addition of a particular stimulus or condition not present prior to the change in configuration of the components (or removal of a particular stimulus or condition, present prior to the change in configuration of the components), and are described in more detail below. In certain cases, a change in temperature may increase the passive diffusion and/or Brownian motion of components present in the droplet but does not result in a change in configuration (e.g., radius of curvature between two components) of the components as described herein (e.g., until exposed to a stimulus).

In some embodiments, the outer phase and at least one component are substantially immiscible. In certain embodiments, the outer phase and at least two components are substantially immiscible. Immiscible, as used herein, refers to two components (or a phase and a component) having an interfacial tension of greater than or equal to 0.01 mN/m as determined by an inverted pendant drop goniometer. Conversely, miscible, as used herein, refers to two components (or a phase and a component) having an interfacial tension of less than 0.01 mN/m as determined by an inverted pendant drop goniometer.

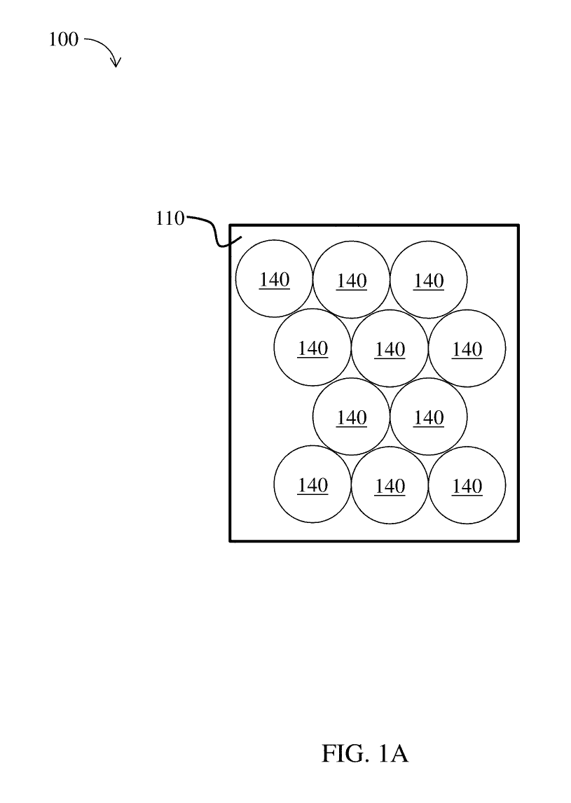

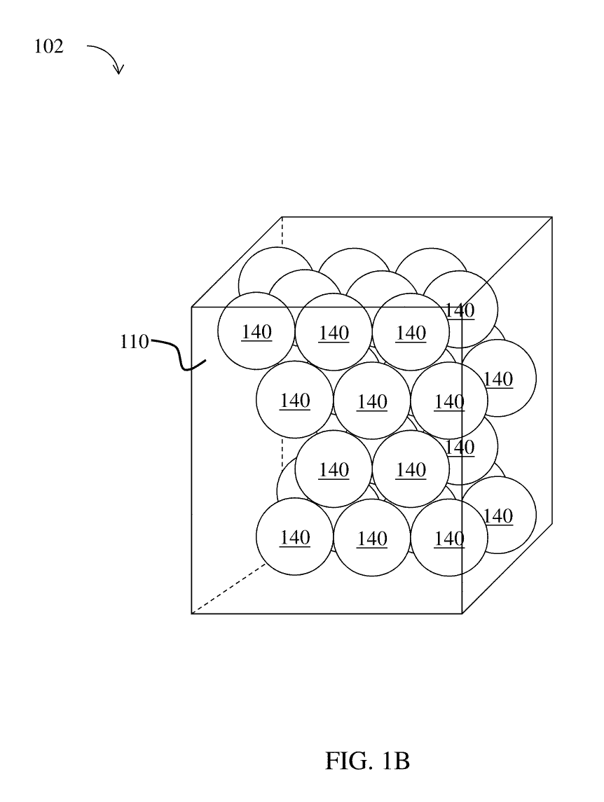

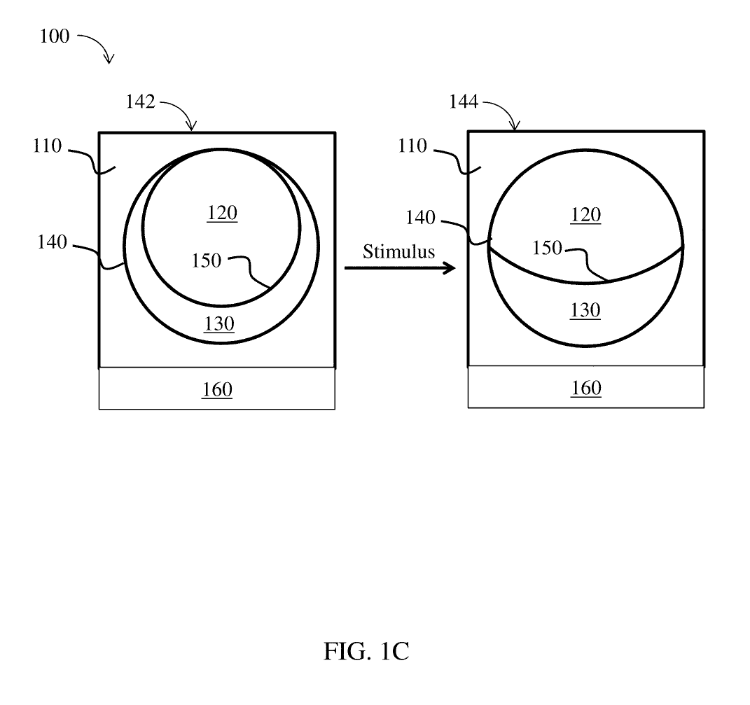

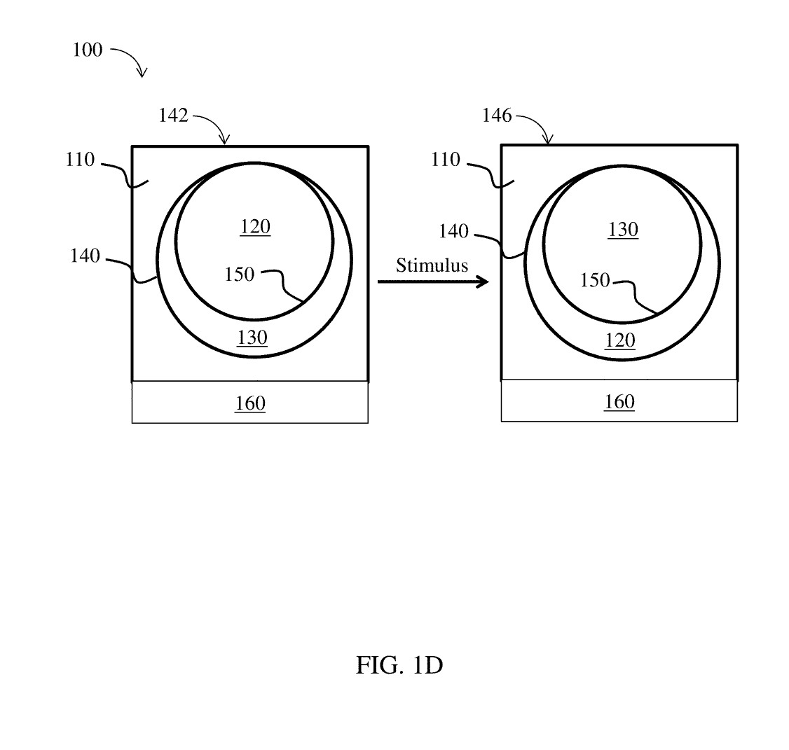

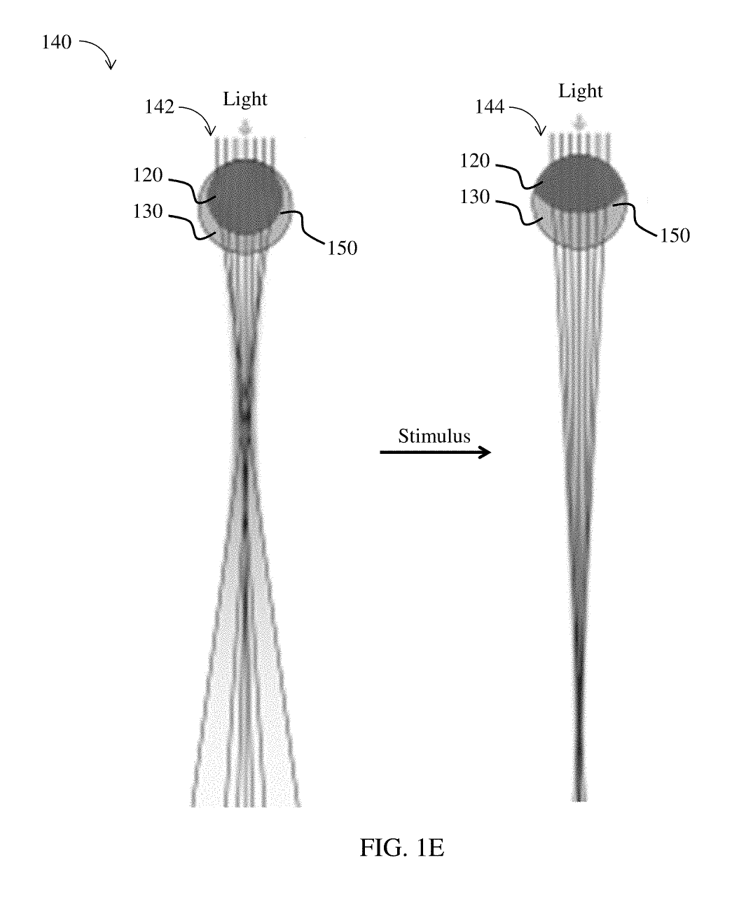

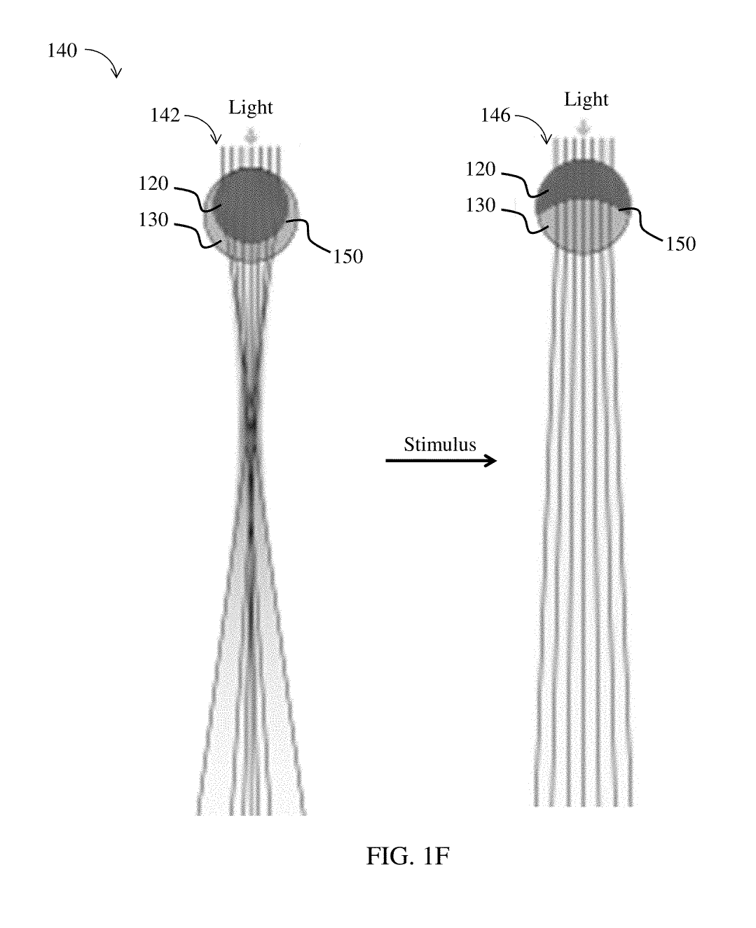

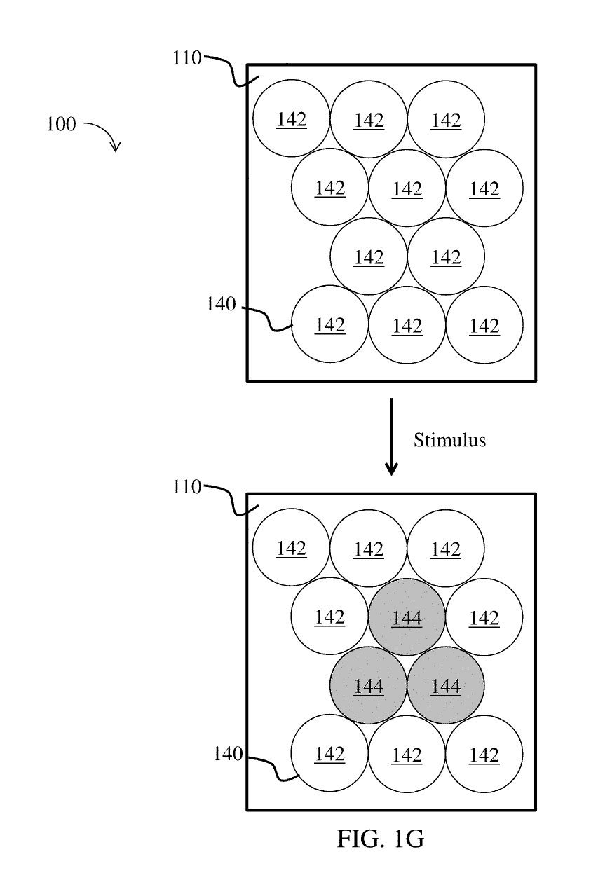

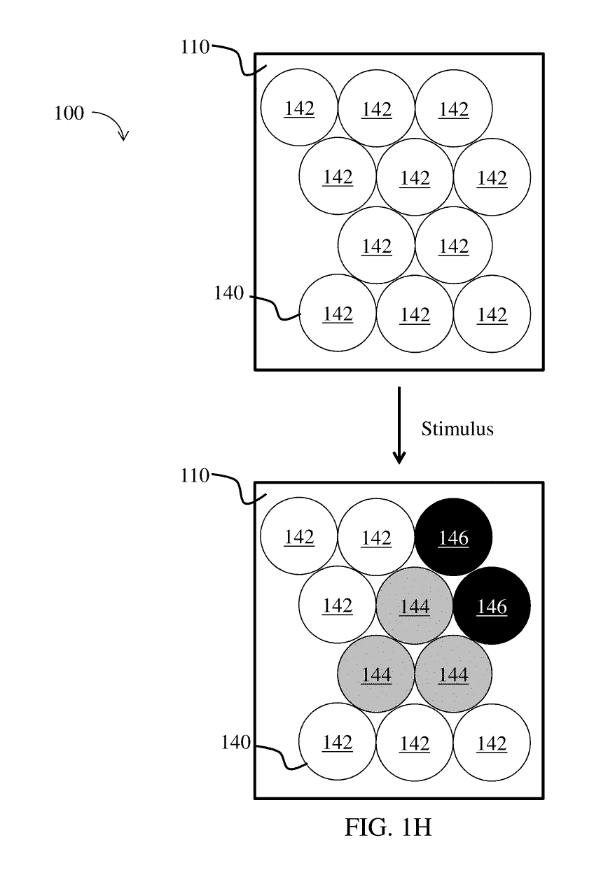

In certain embodiments, the article comprises an array of droplets (e.g., a plurality of droplets arranged in an array). For example, as illustrated in FIG. 1A, article 100 comprises an array of droplets (e.g., comprising a plurality of droplets 140) arranged in a two-dimensional configuration. In certain embodiments, the array of droplets may be dispersed within an outer phase 110. In some cases, as illustrated in FIG. 1B, article 102 comprises an array of droplets (e.g., comprising a plurality of droplets 140) arranged in a three-dimensional configuration.

Droplets described herein offer numerous advantages to droplets known in the art, including the ability to reversibly, dynamically, and/or controllably change the arrangement and/or configuration of the components within the droplets (e.g., in response to an external stimulus, a change in temperature, or an analyte). In some embodiments, the article comprises an outer phase and a plurality of droplets comprising two or more components. For example, in certain embodiments, the article comprises an outer phase and a plurality of droplets comprising a first component and a second component. In some cases, the article comprises an outer phase, and a plurality of droplets comprising a first component, a second component, and a third component. Additional components are also possible. In some embodiments, the plurality of droplets comprise an interface between at least the first component and the second component having a particular radius of curvature. Advantageously, changes in the radius of curvature of the interface(s) described herein may indicate the presence of a stimulus (e.g., an analyte) and/or may be used to reversibly change the focal length of transmitted light through the interface(s). Such articles may be useful for, for example, as tunable compound micro-lenses.

In some embodiments, each droplet 140 (e.g., at least a portion of the droplets in an array of droplets) comprises at least a first component (e.g., a first inner phase) and a second component (e.g., a second inner phase) immiscible with the first component. As illustrated in FIG. 1C, article 100 comprises a droplet 140 (an exemplary droplet within a plurality of droplets) comprising a first component 120 and a second component 130 immiscible with first component 120 and in contact with first component 120 at interface 150. In certain embodiments, the plurality of droplets (e.g., a plurality of droplets 140) are dispersed within an outer phase 110.

In some embodiments, the first component is present in each droplet in an amount greater than or equal to 10 vol %, greater than or equal to 15 vol %, greater than or equal to 20 vol %, greater than or equal to 25 vol %, greater than or equal to 30 vol %, greater than or equal to 35 vol %, greater than or equal to 40 vol %, greater than or equal to 45 vol %, greater than or equal to 50 vol %, greater than or equal to 55 vol %, greater than or equal to 60 vol %, greater than or equal to 65 vol %, greater than or equal to 70 vol %, greater than or equal to 75 vol %, greater than or equal to 80 vol %, or greater than or equal to 85 vol % on average versus the total volume of all components within each droplet. In certain embodiments, the first component is present in each droplet in an amount less than or equal to 90 vol %, less than or equal to 85 vol %, less than or equal to 80 vol %, less than or equal to 75 vol %, less than or equal to 70 vol %, less than or equal to 65 vol %, less than or equal to 60 vol %, less than or equal to 55 vol %, less than or equal to 50 vol %, less than or equal to 45 vol %, less than or equal to 40 vol %, less than or equal to 35 vol %, less than or equal to 30 vol %, less than or equal to 25 vol %, less than or equal to 20 vol %, or less than or equal to 15 vol % on average versus the total volume of all components within each droplet. Combinations of the above-referenced ranges are also possible (e.g., greater than or equal to 10 vol % and less than or equal to 90 vol %, greater than or equal to 35 vol % and less than or equal to 65 vol %, greater than or equal to 45 vol % and less than or equal to 55 vol %). Other ranges are also possible.

In certain embodiments, the second component is present in each droplet in an amount greater than or equal to 10 vol %, greater than or equal to 15 vol %, greater than or equal to 20 vol %, greater than or equal to 25 vol %, greater than or equal to 30 vol %, greater than or equal to 35 vol %, greater than or equal to 40 vol %, greater than or equal to 45 vol %, greater than or equal to 50 vol %, greater than or equal to 55 vol %, greater than or equal to 60 vol %, greater than or equal to 65 vol %, greater than or equal to 70 vol %, greater than or equal to 75 vol %, greater than or equal to 80 vol %, or greater than or equal to 85 vol % on average versus the total volume of all components within each droplet. In some embodiments, the second component is present in each droplet in an amount less than or equal to 90 vol %, less than or equal to 85 vol %, less than or equal to 80 vol %, less than or equal to 75 vol %, less than or equal to 70 vol %, less than or equal to 65 vol %, less than or equal to 60 vol %, less than or equal to 55 vol %, less than or equal to 50 vol %, less than or equal to 45 vol %, less than or equal to 40 vol %, less than or equal to 35 vol %, less than or equal to 30 vol %, less than or equal to 25 vol %, less than or equal to 20 vol %, or less than or equal to 15 vol % on average versus the total volume of all components within each droplet. Combinations of the above-referenced ranges are also possible (e.g., greater than or equal to 10 vol % and less than or equal to 90 vol %, greater than or equal to 35 vol % and less than or equal to 65 vol %, greater than or equal to 45 vol % and less than or equal to 55 vol %). Other ranges are also possible.

In an exemplary set of embodiments, the plurality of droplets comprise the first component in an amount of greater than or equal to 35 vol % and less than or equal to 65 vol % and the second component in the remaining amount versus the total volume of the first and second components in the droplets.

As described above and herein, the plurality of droplets may be arranged in a two-dimensional or three-dimensional array. The phrase “two-dimensional array” is given its ordinary meaning in the art and generally refers to the ordered arrangement of objects (e.g., droplets) in e.g., ordered rows and columns in a two-dimensional plane comprising said objects. The phrase “three-dimensional array” is given its ordinary meaning in the art and generally refers to the ordered arrangement of objects (e.g., droplets) in e.g., ordered rows, columns, and slices (or planes) in a three-dimensional space.

Any terms as used herein related to shape, orientation, alignment, and/or geometric relationship of or between, for example, one or more droplets, components, combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, alignment, and/or geometric relationship include, but are not limited to terms descriptive of: shape—such as, round, square, circular/circle, rectangular/rectangle, triangular/triangle, cylindrical/cylinder, elipitical/elipse, (n)polygonal/(n)polygon, U-shaped, line-shaped, etc.; angular orientation—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; arrangement—array, row, column, etc. As one example, a fabricated article that would described herein as being “square” would not require such article to have faces or sides that are perfectly planar or linear and that intersect at angles of exactly 90 degrees (indeed, such an article can only exist as a mathematical abstraction), but rather, the shape of such article should be interpreted as approximating a “square,” as defined mathematically, to an extent typically achievable and achieved for the recited fabrication technique as would be understood by those skilled in the art or as specifically described. As another example, a plurality of droplets that would be described herein as being in an “array” would not require such droplets to have centers that are perfectly arranged in row and columns in which all major axes of the droplets are aligned (indeed, such an array can only exist as a mathematical abstraction), but rather, the arrangement of such droplets should be interpreted as approximating an “array”, as defined mathematically, to an extent typically achievable and achieved for the recited fabrication technique as would be understood by those skilled in the art or as specifically described.

In some embodiments, at least 10% of the plurality of droplets in the article are in physical contact with each other. For example, at least 10%, at least 20%, at least 30%, at least 40%, at least 50%, at least 60%, at least 70%, at least 80%, or at least 90% of the droplets in the article are in contact with at least one other droplet. In some embodiments, less than or equal to 100%, less than or equal to 90%, less than or equal to 80%, less than or equal to 70%, less than or equal to 60%, less than or equal to 50%, less than or equal to 40%, less than or equal to 30%, or less than or equal to 20% of the droplets in the article are in contact with at least one other droplet. Combinations of the above-referenced ranges are also possible (e.g., at least 10% and less than or equal to 100%). Other ranges are also possible.

In some embodiments, at least 10%, at least 20%, at least 30%, at least 40%, at least 50%, at least 60%, at least 70%, at least 80%, or at least 90% of the droplets in the article are arranged in a regular two-dimensional array. In some embodiments, less than or equal to 100%, less than or equal to 90%, less than or equal to 80%, less than or equal to 70%, less than or equal to 60%, less than or equal to 50%, less than or equal to 40%, less than or equal to 30%, or less than or equal to 20% of the droplets in the article are arranged in a regular two-dimensional array. Combinations of the above-referenced ranges are also possible (e.g., at least 10% and less than or equal to 100%). Other ranges are also possible.

In certain embodiments, at least 10%, at least 20%, at least 30%, at least 40%, at least 50%, at least 60%, at least 70%, at least 80%, or at least 90% of the droplets in the article are arranged in a regular three-dimensional array. In some embodiments, less than or equal to 100%, less than or equal to 90%, less than or equal to 80%, less than or equal to 70%, less than or equal to 60%, less than or equal to 50%, less than or equal to 40%, less than or equal to 30%, or less than or equal to 20% of the droplets in the article are arranged in a regular three-dimensional array. Combinations of the above-referenced ranges are also possible (e.g., at least 10% and less than or equal to 100%). Other ranges are also possible.

The plurality of droplets may have a first configuration (e.g., arrangement of two or more phases within each droplet, radius of curvature between two or more phases within each droplet) under a first set of conditions. For example, in the first configuration, the interface between a first phase and a second phase may have a first radius of curvature. In certain embodiments, at least a portion of the plurality of droplets has a second configuration, different than the first configuration, under a second set of conditions different than the first set of conditions. In some embodiments, in the second configuration, the interface between the first phase and the second phase may have a second radius of curvature, different than the first radius of curvature.

In some embodiments, the article comprising an outer phase and a plurality of droplets is adjacent a substrate.

For example, referring again to FIG. 1C, substrate 160 may be adjacent (e.g., directly adjacent) outer phase 142. The substrate may comprise any suitable material including, but not limited to, metals, polymers, ceramics, glass, biological tissue, amongst others. Those of ordinary skill in the art would be capable of selecting suitable substrates for forming articles described herein based upon the teachings of the specification. In some cases, the substrate may be transparent. In other embodiments, the substrate may be selected to be at least partially opaque. In some cases, the substrate may comprise one or more images (e.g., designs, graphics, text, QR code, barcodes, or the like) and/or features (e.g., posts, ridges, holes, embossed features, debossed features, or the like) present on at least a portion of a surface of the substrate. In some cases, the images and/or features may be visible through the article adjacent the substrate, under a first set of conditions. In certain embodiments, the images and/or features may change in color (e.g., wavelength), focus, magnification, visibility, intensity, and/or orientation (e.g., inverted) when viewed through the article adjacent the substrate, under a second set of conditions, different than the first set of conditions. In an exemplary set of embodiments, the images and/or features present on a surface of a substrate may be magnified when viewed through the article adjacent the substrate under a second set of conditions, as compared to the images and/or features under a first set of conditions different than the second set of conditions.

As used herein, when an article is referred to as being “adjacent” a substrate, it can be directly adjacent to the substrate, or one or more intervening components (e.g., layers including, but not limited to, a polymer layer, a glass layer, a coating, and/or a fluid) also may be present. An article that is “directly adjacent” a substrate means that no intervening component is present.

The first set of conditions may include the temperature, pressure, pH, an electric field, a magnetic field, and/or presence or absence of a particular stimulus such that the second set of conditions includes at least a temperature, pressure, pH, an electric field, a magnetic field, and/or presence or absence of a particular stimulus that is different than the first set of conditions. In some embodiments, the second set of conditions has a different temperature than the first set of conditions (e.g., other conditions such as pressure, pH, an electric field, a magnetic field, etc. may or may not be substantially similar). In certain embodiments, the second set of conditions comprises a stimulus that was not present, or was present in a substantially lesser amount, than in the first set of conditions. For example, in some embodiments, the plurality of droplets may have a first configuration and, upon exposure to a stimulus, at least a portion of the droplets obtain a second configuration different than the first configuration.

For example, referring again to FIG. 1C, article 100 may comprise a droplet 140 (or a plurality of droplets 140) having a first configuration 142. Upon exposure to a stimulus, droplet 140 may obtain a second configuration 144, different than first configuration 142. In some embodiments, droplet 140 comprises an interface 150 between first component 120 and second component 130. In certain embodiments, interface 150 may have a particular radius of curvature (e.g., a first radius of curvature under first configuration 142). In some cases, the radius of curvature of interface 150 may change (e.g., a second radius of curvature, different than the first radius of curvature, under second configuration 144). For example, upon exposure to a stimulus, the second configuration may have a radius of curvature between two phases and/or an average focal length for transmitted or reflected light that is different than the radius of curvature between two phases and/or the average focal length for transmitted or reflected light in the first configuration. Radius of curvature between two phases and average focal lengths are described in more detail, herein.

In some embodiments, exposing the article to a stimulus may cause two or more components to transpose. Referring to FIG. 1D, in some embodiments, article 100 comprises an outer phase 110, and a plurality of droplets (shown as exemplary droplet 140) comprising a first component 120 and a second component 130 at least partially encapsulated by the first component (configuration 142). In certain embodiments, article 100 having configuration 100A may be stimulated (e.g., by a first stimulus) such that at least a portion of the plurality of droplets obtain a second configuration 146, such that second component 130 at least partially encapsulates first component 120. That is to say, in certain embodiments, the first component and the second component may transpose. In some embodiments, the rearrangement between the first configuration and the second configuration may be reversible. For example, in some cases, article 100 comprising a plurality of droplets having second configuration 146 may be stimulated (e.g., by a second stimulus) such that at least a portion of the plurality of droplets return to first configuration 142. In certain embodiments, the radius of curvature between the two components may be substantially similar before and after exposure to the stimulus, but the average focal length for transmitted or reflected light may be different before and after exposure to the stimulus.

In some cases, the radius of curvature of the interface (e.g., in the first configuration) may be positive. For example, referring again to FIG. 1C, in some embodiments, the outer phase may be arranged (e.g., disposed on, in direct contact with) on a substrate 160. In some cases, the radius of curvature of the interface (e.g., interface 150) is such that light transmitted through the droplet converges at the interface. In certain embodiments, the radius of curvature of the interface is such that light transmitted through the droplet diverges at the interface. For example, in some cases, the radius of curvature of interface 150 (e.g., in a first configuration) may be greater than 0. In certain embodiments, the radius of curvature of interface 150 (e.g., in a first configuration) may be less than 0. In some embodiments, the radius of curvature of interface 150 may be 0 (e.g., in some cases, interface 150 may be parallel to a major plane of the surface of the substrate). Those of ordinary skill in the art would understand how to determine the radius of curvature of the interface based on the teachings of this specification.

In some embodiments, the magnitude of the radius of curvature of the interface may increase upon exposure of the droplets to a stimulus. For example, the magnitude of the radius of curvature of the interface in the second configuration may be greater than or equal to 1.1, greater than or equal to 1.5, greater than or equal to 2, greater than or equal to 3, greater than or equal to 5, greater than or equal to 10, greater than or equal to 50, greater than or equal to 100, greater than or equal to 500, greater than or equal to 1000, greater than or equal to 5000, greater than or equal to 10000, or greater than or equal to 100000 times greater than the radius of curvature of the interface in the first configuration. In some embodiments, the magnitude of the radius of curvature of the interface in the second configuration may be less than or equal to 1000000, less than equal to 100000, less than equal to 10000, less than equal to 5000, less than equal to 1000, less than equal to 500, less than equal to 100, less than equal to 50, less than equal to 10, less than equal to 5, less than equal to 3, less than or equal to 2, or less than or equal to 1.5 times greater than the magnitude of the radius of curvature of the interface in the first configuration. Combinations of the above-referenced ranges are possible (e.g., greater than or equal to 1.1 and less than or equal to 1000000 times greater). Other ranges are also possible.

In some embodiments, the magnitude of the radius of curvature of the interface may decrease upon exposure of the droplets to a stimulus. For example, the magnitude of the radius of curvature of the interface in the first configuration may be greater than or equal to 1.1, greater than or equal to 1.5, greater than or equal to 2, greater than or equal to 3, greater than or equal to 5, greater than or equal to 10, greater than or equal to 50, greater than or equal to 100, greater than or equal to 500, greater than or equal to 1000, greater than or equal to 5000, greater than or equal to 10000, or greater than or equal to 100000 times greater than the radius of curvature of the interface in the second configuration. In some embodiments, the magnitude of the radius of curvature of the interface in the first configuration may be less than or equal to 1000000, less than equal to 100000, less than equal to 10000, less than equal to 5000, less than equal to 1000, less than equal to 500, less than equal to 100, less than equal to 50, less than equal to 10, less than equal to 5, less than equal to 3, less than or equal to 2, or less than or equal to 1.5 times greater than the magnitude of the radius of curvature of the interface in the second configuration. Combinations of the above-referenced ranges are possible (e.g., greater than or equal to 1.1 and less than or equal to 1000000 times greater). Other ranges are also possible.

In certain embodiments, the radius of curvature of the interface may be greater than 0 in the first configuration and less than 0 in the second configuration. In some embodiments, the radius of curvature of the interface may be less than 0 in the first configuration and greater than 0 in the second configuration. In some cases, the radius of curvature of the interface may be less than 0 in the first configuration and less than 0 in the second configuration, but different in magnitude than the first configuration. In some embodiments, the radius of curvature of the interface may be greater than 0 in the first configuration and greater than 0 in the second configuration, but different in magnitude than the first configuration. In some cases, the magnitude of the radius of curvature of the interface may be substantially the same in the first configuration and the second configuration. In some such embodiments, the relative positions of the first component and the second component relative to one another may transpose. For example, as illustrated schematically in FIG. 1D, the radius of curvature of interface 150 is substantially the same in first configuration 142 and second configuration 146, while first component 120 and second component 130 have transposed between the first and second configurations. In other embodiments, the radius of curvature of interface 150 may be different in the first and second configurations.

Non-limiting examples of stimuli include a change in electromagnetic radiation (e.g., light), ionizing radiation, a magnetic field, an electric field, a mechanical force, adjusting the ionic strength of the outer phase, adjusting the temperature of the outer phase, exposing the plurality of droplets to photochemical stimulation, adding an analyte to the outer phase, applying an electric or magnetic field, or combinations thereof.

In some embodiments, the average focal length for transmitted or reflected light of at least a portion of the droplets in the article may change upon exposure to a stimulus. For example, as illustrated in FIG. 1E, an article comprising exemplary droplet 140 may have a first configuration 142, such that the first configuration has a first average focal length for transmitted or reflected light. For example, the radius of curvature of interface 150 may be such that transmitted light interacts with the interface, causing the transmitted light to exhibit a particular average focal length. In some embodiments, upon exposure to a stimulus, droplet 140 may obtain a second configuration 144 (e.g., such that the radius of curvature between first component 120 and second component 130 at interface 150 in the second configuration is different than the radius of curvature between first component 120 and second component 130 at interface 150 in the first configuration). The second configuration 144 may have a second average focal length for transmitted or reflected light, different than the average focal length for transmitted or reflected light of first configuration 142. In certain embodiments, transmitted or reflected light exposed to the droplet focuses (e.g., as shown in first configuration 142 in FIG. 1E). In some embodiments, the transmitted or reflected light exposed to the droplet may diverge. For example, as shown illustratively in FIG. 1F, upon exposure to a stimulus, droplet 140 may obtain a second configuration 146 such that transmitted or reflected light exposed to the droplet diverges. For example, the radius of curvature of interface 150 in configuration 142 may be such that the transmitted or reflected light exposed to the droplet has a particular focal length and, upon stimulation of droplet 140 such that it obtains second configuration 146, the radius of curvature of interface 150 in configuration 146 is such that the transmitted or reflected light diverges.

In certain embodiments, the plurality of droplets have a first average focal length for transmitted or reflected light under a first set of conditions, and the plurality of droplets have a second average focal length for transmitted or reflected light different than the first average focal length under a second set of conditions, different than the first set of conditions. In some cases, the plurality of droplets may have a first average radius of curvature between the first component and the second component (e.g., at the interface between the first component and the second component) under the first set of conditions (e.g., that causes light rays to focus), and the plurality of droplets have a second average radius of curvature between the first component and the second component under a second set of conditions, different than the first set of conditions. In some cases, the average focal length for transmitted or reflected light may change as the radius of curvature at the interface between the first component and the second component changes.

In some embodiments, at least a first portion of the plurality of droplets in an array may have a first average focal length for transmitted or reflected light. In certain embodiments, at least a second portion of the plurality of droplets in the array may have a second average focal length for transmitted or reflect light, different than the first average focal length. In some embodiments, the first portion of the plurality of droplets may be stimulated (e.g., exposed to an analyte) such that the first average focal length changes (e.g., increases, decreases). In some embodiments, at least a first portion of the plurality of droplets has a first radius of curvature between the first component and the second component (e.g., that causes light rays to focus), and at least a second portion of the plurality of droplets has a second radius of curvature between the first component and the second component, different than the first radius of curvature. In some cases, the first portion of the plurality of droplets may be stimulated (e.g., exposed to an analyte) such that the first radius of curvature changes (e.g., increases, decreases).

While the embodiments and figures described herein show a first configuration (e.g., first configuration 142) such that transmitted or reflected light focuses, those of ordinary skill in the art would understand based upon the teachings of this specification that the transmitted or reflected light may diverge in the first configuration. For example, in some cases, the first configuration may be such that transmitted light diverges and the second configuration may be such that transmitted light focuses. In certain embodiments, the first configuration may be such that transmitted light diverges and the second configuration may be such that transmitted light diverges in a different amount (e.g., such that the average focal length is different in the second configuration than in the first configuration). Other configurations such that transmitted or reflected light focuses or diverges may be possible. In some cases, the average focal length in the first and second configurations may be different. In certain embodiments, the amount of divergent transmitted light between the first and second configurations may be different.

In certain embodiments, as described herein, the plurality of droplets may be exposed to a source of electromagnetic radiation (e.g., visible light), such that at least a portion of the electromagnetic radiation (e.g., a particular wavelength or range of wavelengths) is at least partially transmitted (e.g., such that at least some electromagnetic radiation passes through the droplet) through the droplet. In some cases, at least a portion of the electromagnetic radiation may be reflected off of at least a surface (e.g., a surface of the first component, a surface of the second component, a surface of the interface between the first component and the second component) of the droplet. The electromagnetic radiation (e.g., light) may comprise any suitable wavelength, including but not limited to radio waves (e.g., a wavelength between about 1 cm and about 100 m), infrared light (e.g., a wavelength between about 700 nm and about 1 cm), visible light (e.g., a wavelength between about 400 nm and about 700 nm), ultraviolet (UV) light (e.g., a wavelength between about 10 nm and about 400 nm), x-rays (e.g., a wavelength between about 0.01 nm and about 10 nm), and combinations thereof.

As described herein, the electromagnetic radiation transmitted through and/or reflected by the droplet may be detected (e.g., visibly by a user, by a sensor, etc.). In certain embodiments, a change in electromagnetic radiation (e.g., focal length through the droplet, intensity, frequency, and/or range) may be detected upon stimulation of the droplet (e.g., such that at least a portion of the plurality of droplets in an array change configuration upon exposure to a stimulus). In some cases, the detection of a change in the transmitted (or reflected) electromagnetic radiation may indicate the presence of stimulus (e.g., the presence of an analyte e.g., that interacts with the plurality of droplets).

In some embodiments, as described herein, at least a portion of the plurality of droplets in an array change configuration upon exposure to a stimulus (e.g., a stimulus added to the outer phase of the article). For example, as shown illustratively in FIG. 1G, article 100 comprises an array of droplets 140 dispersed in an outer phase 110, each droplet having a first configuration 142. In certain embodiments, upon exposure to a stimulus, at least a portion of the droplets in the array change configuration to obtain second configuration 144. In some embodiments, upon exposure to a stimulus, at least a first portion of the droplets in the array obtain a second configuration 144 and at least a second portion of the droplets in the array obtain a third configuration 146. For example, as illustrated in FIG. 1H, upon exposure to a stimulus, at least a portion of droplets 140 in the array have first configuration 142, a second portion of the droplets have second configuration 144, and a third portion of the droplets have third configuration 146. In some embodiments, a plurality of configurations upon exposure to a stimulus are also possible. For example, in certain embodiments, an article comprising an array of a plurality of droplets may, upon exposure to a stimulus, have a gradient of configurations.

As described herein, the article may comprise, in some cases, a plurality of droplets having a particular average focal length. In some embodiments, one or more components (e.g., the first component, the second component) are configured to be transparent to at least one wavelength of electromagnetic radiation (e.g., x-rays, ultraviolet, visible, IR, etc.). For example, in some embodiments, the first component is transparent to visible light such that, upon exposure of the droplet to the visible light, the visible light interacts with the interface between the first component and the second component and changes the average focal length and/or of the visible light.

In certain embodiments, the plurality of droplets comprises two or more components, each having a particular refractive index. For example, in some embodiments, the refractive index of the first component may be different than the refractive index of the second component. In some embodiments, the refractive index of the first component may be greater than the refractive index of the second component. In certain embodiments, the refractive index of the first component may be less than the refractive index of the second component. Suitable materials for the components of the droplets are described in more detail below. Those of ordinary skill in the art would be capable of selecting components with suitable refractive indices based upon the teachings of this specification.

In some embodiments, the refractive index of the first component may be greater than or equal to 1.2, greater than or equal to 1.25, greater than or equal to 1.3, greater than or equal to 1.35, greater than or equal to 1.4, greater than or equal to 1.45, greater than or equal to 1.5, or greater than or equal to 1.55. In certain embodiments, the refractive index of the first component may be less than or equal to 1.6, less than or equal to 1.55, less than or equal to 1.5, less than or equal to 1.45, less than or equal to 1.4, less than or equal to 1.35, less than or equal to 1.3, or less than or equal to 1.25. Combinations of the above referenced ranges are also possible (e.g., greater than or equal to 1.2 and less than or equal to 1.6, greater than or equal to 1.25 and less than or equal to 1.4, greater than or equal to 1.2 and less than or equal to 1.3). Other ranges are also possible.

In some embodiments, the refractive index (measured at 20° C.) of the second component may be greater than or equal to 1.2, greater than or equal to 1.25, greater than or equal to 1.3, greater than or equal to 1.35, greater than or equal to 1.4, greater than or equal to 1.45, greater than or equal to 1.5, or greater than or equal to 1.55. In certain embodiments, the refractive index (measured at 20° C.) of the second component may be less than or equal to 1.6, less than or equal to 1.55, less than or equal to 1.5, less than or equal to 1.45, less than or equal to 1.4, less than or equal to 1.35, less than or equal to 1.3, or less than or equal to 1.25. Combinations of the above referenced ranges are also possible (e.g., greater than or equal to 1.2 and less than or equal to 1.6, greater than or equal to 1.25 and less than or equal to 1.4, greater than or equal to 1.3 and less than or equal to 1.4). Other ranges are also possible. Refractive index, as used herein, refers to the refractive index of the component measured at 20° C. Those of ordinary skill in the art would be capable of selecting suitable methods for determining the refractive index of a component, based upon the teachings of this specification.

In certain embodiments, a magnitude of a difference in refractive index between the refractive index of the first component and the refractive index of the second component may be greater than or equal to 0.05, greater than or equal to 0.1, greater than or equal to 0.15, or greater than or equal to 0.2. In some embodiments, the magnitude of the difference in refractive index between the refractive index of the first component and the refractive index of the second component may be less than or equal to 0.25, less than or equal to 0.2, less than or equal to 0.15, or less than or equal to 0.1. Combinations of the above-referenced ranges are also possible (e.g., greater than or equal to 0.05 and less than or equal to 0.25). Other ranges are also possible.

While exemplary configurations for a plurality of droplets having two or more components, are described above, those skilled in the art would understand based upon the teaching of this specification that additional reconfigurations and rearrangements are also possible (e.g., the third component encapsulating the first and second components, etc.). Those skilled in the art would also understand, based upon the teachings of this specification, that droplets comprising four or more, five or more, or six or more components are also possible and that such droplets may also be stimulated such that two or more of the components have a radius of curvature between the two or more components that changes upon exposure to a stimulus.

The article may be stimulated for any suitable amount of time. For example, in some cases, the stimulus is added to the outer phase and not removed. In certain embodiments, the stimulus is applied for a specific amount of time. In some such embodiments, the stimulus may be applied for between about 1 second and about 10 seconds, between about 5 seconds and about 60 seconds, between about 30 seconds and about 2 minutes, between about 1 minute and about 5 minutes, between about 2 minutes and about 10 minutes, between about 5 minutes and about 15 minutes, between about 10 minutes and about 30 minutes, between about 15 minutes and about 60 minutes, between about 30 minutes and about 2 hours, between about 1 hour and about 6 hours, or between about 2 hours and about 24 hours. In some cases, the colloid may be stimulated for greater than 24 hours.

The term component, as used herein, generally refers to a portion of a droplet comprising a group of substantially similar molecules, a group of substantially similar compounds, and/or a phase (e.g., a non-aqueous phase, an aqueous phase) comprising such molecules and/or compounds. Those skilled in the art would understand that the term component is not intended to refer to a single molecule or atom. In some embodiments, the component is a liquid phase (e.g., a gas phase, an aqueous phase, non-aqueous phase) comprising a group of substantially similar compounds and/or molecules. For example, in some cases, each component may occupy at least about 1 vol %, at least about 2 vol %, at least about 5 vol %, at least about 10 vol %, at least about 20 vol %, at least about 50 vol %, at least about 70 vol %, at least about 90 vol %, at least about 95 vol %, or at least about 99 vol % of the total volume of the two or more components present within each droplet.

In some embodiments, the plurality of droplets comprise two or more components (e.g., three or more components, four or more components, five or more components) such that at least two of the two or more components change configuration (e.g., change radius of curvature between the two or more components, change the average focal length of the droplets) in the presence of a stimulus.

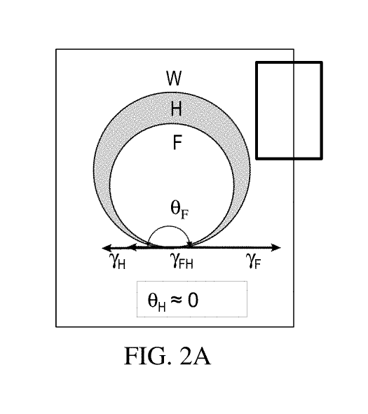

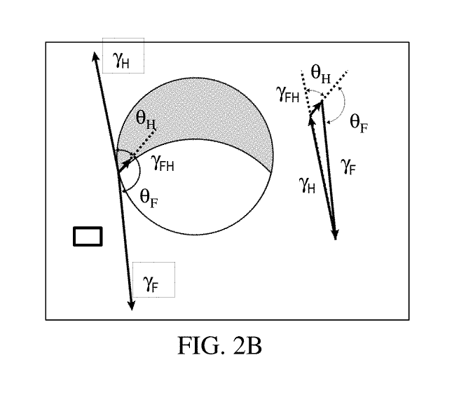

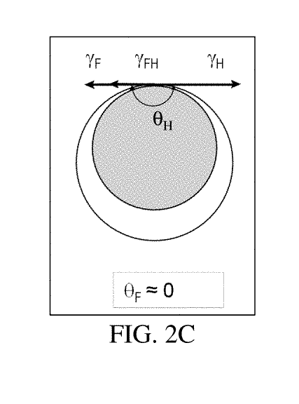

In some embodiments, the two or more components may be selected such that the interfacial tension between the two or more components allows for slight changes in interfacial tension (e.g., in response to a stimulus that changes the conformation and/or a property of the one or more components) to change the configuration of the two or more components within at least a portion of the plurality of droplets. Without wishing to be bound by theory, the morphology of the plurality of droplets is generally controlled by interfacial tension between two or more components within the droplets. For example, a droplet of any immiscible liquids F and H (at a given volume ratio) in a third immiscible liquid W has interfacial tensions of the H-W interface, γ_{H}, the F-W interface, γ_{F}, and the F-H interface, γ_{FH}. In some cases, γ_{F} and γ_{H} may be greater than γ_{FH} such that combinations of liquids H and F have low interfacial tension just below a critical temperature of the two liquids. Generally, such multi-phase droplets may have equilibrium spherical shapes and may exhibit, for example, thermodynamically-permissible internal configurations including (1) liquid H completely engulfs liquid F (FIG. 2A), (2) liquids H and F form a Janus droplet (FIG. 2B), and (3) liquid F completely engulfs liquid H (FIG. 2C). These droplet configurations may be characterized, in some cases, by two contact angles, θ_{H} between the H-W and F-H interfaces, and θ_{F} between the F-H and F-W interfaces. The three interfacial tensions acting along the interfaces must be in equilibrium for the droplet configuration to be stable as can be expressed by the following equations:

$$cos {θ}_{H} = \frac{{γ}_{F}^{2} - {γ}_{H}^{2} - {γ}_{FH}^{2}}{2 {γ}_{FH} {γ}_{H}}$$

$$cos {θ}_{F} = \frac{{γ}_{H}^{2} - {γ}_{F}^{2} - {γ}_{FH}^{2}}{2 {γ}_{FH} {γ}_{F}}$$

In some cases, θ_{H} approaches 0 and θ_{F} approaches 0, yielding the following two relationships:

θ_{H}=0⇒γ_{F}=γ_{H}+γ_{FH}

θ_{F}=0⇒γ_{H}=γ_{F}+γ_{FH}

These equations generally indicate that when γ_{F}−γ_{H}≥γ_{FH}, the droplets can rearrange to configuration (1) in FIG. 2A. Conversely, when γ_{H}−γ_{F}≥γ_{FH}, the droplets can rearrange to configuration (3) in FIG. 2C. However, when the difference between γ_{H} and γ_{F} is on the order of γ_{FH}, the droplets can rearrange to a Janus droplet geometry associated with configuration (2) in FIG. 2B. As such, slight changes in the balance of γ_{H} and γ_{F} may induce changes in the droplet's morphology. In some embodiments, the two or more components may be selected such that changes in the balance of γ_{H} and γ_{F} result in the reversible change of configuration of the two or more components within a portion of the plurality of droplets.

In some embodiments, the droplet configuration may be characterized, in some embodiments, by a radius of curvature between two or more components (e.g., the F-H interface). The internal curvature may be set by the balance of interfacial tensions at the triple-phase contact line given by

$$\frac{{γ}_{H} - {γ}_{F}}{{γ}_{H F}} = ( {R}_{d}^{2} + 2 {R}_{i} l - {l}^{2} ) / ( 2 {R}_{i} {R}_{d} )$$

Where R_{d} is the radius of the droplet and R₁ is the internal radius of curvature (i.e. the radius of curvature between the interface between the first component and the second component such as the F-H interface).

In certain embodiments, each component is different and a fluid. In some cases, one or more components may be a gas. In some embodiments, one or more components may be a liquid.

In some embodiments, at least one of the two or more components comprises a hydrocarbon (e.g., a hydrocarbon fluid). Non-limiting examples of suitable hydrocarbons include alkanes (e.g., hexane, heptane, decane, dodecane, hexadecane), alkenes, alkynes, aromatics (e.g., benzene, toluene, xylene, benzyl benzoate, diethyl phalate), oils (e.g., natural oils and oil mixtures including vegetable oil, mineral oil, and olive oil), liquid monomers and/or polymers (e.g., hexanediol diacrylate, butanediol diacrylate, polyethylene glycols, trimethylolpropane ethoxylate triacrylate), alcohols (e.g., butanol, octanol, pentanol, ethanol, isopropanol), ethers (e.g., diethyl ether, diethylene glycol, dimethyl ether), dimethyl formamide, acetonitrile, nitromethane, halogenated liquids (e.g., chloroform, dichlorobenzene, methylene chloride, carbon tetrachloride) brominated liquids, iodinated liquids, lactates (e.g., ethyl lactate), acids (e.g., citric acid, acetic acid), trimethylamine, liquid crystal hydrocarbons (e.g., 5-cyanobiphenyl), combinations thereof, and derivatives thereof, optionally substituted. In some embodiments, the hydrocarbon comprises a halogen group, sulfur, nitrogen, phosphorous, oxygen, or the like. Other hydrocarbons or organic chemicals are also possible. In some embodiments, the outer phase comprises a hydrocarbon.

In certain embodiments, the hydrocarbon may be selected based upon its refractive index and/or transmissivity to a particular wavelength of electromagnetic radiation (e.g., visible light). In some embodiments, the hydrocarbon may be substantially transparent to visible light.

In some embodiments, at least one of the two or more components comprises a fluorocarbon (e.g., a fluorocarbon fluid). Non-limiting examples of suitable fluorocarbons include fluorinated compounds such as perfluoroalkanes (e.g., perfluorohexanes, perfluorooctane, perfluorodecalin, perfluoromethylcyclohexane), perfluoroalkenes (e.g., perfluorobenzene), perfluoroalkynes, and branched fluorocarbons (e.g., perfluorotributylamine). Additional non-limiting examples of suitable fluorocarbons include partially fluorinated compounds such as methoxyperfluorobutane, ethyl nonafluorobutyl ether, 2H,3H-perfluoropentane, trifluorotoluene, perfluoroidodide, fluorinated or partially fluorinated oligomers, 2,2,3,3,4,4,5,5,6,6,7,7,8,8,9,9-hexadecafluorodecane-1,10-diyl bis(2-methylacrylate), perfluoroiodide, and 2-(trifluoromethyl)-3-ethoxydodecafluorohexane. Other fluorocarbons are also possible. In some embodiments, the outer phase comprises a fluorocarbon.

In certain embodiments, the fluorocarbon may be selected based upon its refractive index and/or transmissivity to a particular wavelength of electromagnetic radiation (e.g., visible light). In some embodiments, the fluorocarbon may be substantially transparent to visible light.

In some embodiments, at least one of the two or more components comprises a silicone such as silicone oil. Non-limiting examples of suitable silicone oils include polydimethylsiloxane and cyclosiloxane fluids. In some embodiments, the outer phase comprises a silicone.

In certain embodiments, the composition of each component (e.g., the first component, the second component) may be selected based upon its refractive index and/or transmissivity to a particular wavelength of electromagnetic radiation (e.g., visible light). In some embodiments, each component may be substantially transparent to visible light.

In some embodiments, at least one of the two or more components comprises water. In some embodiments, at least one of the two or more components comprises an ionic liquid (e.g., an electrolyte, a liquid salt). Non-limiting examples of ionic liquids include 1-allyl-3-methylimidazolium bromide, 1-allyl-3-methylimidazolium chloride, 1-benzyl-3-methylimidazolium hexafluorophosphate, 1-butyl-1-methylpyrrolidinium hexafluorophosphate. Other ionic liquids are also possible. In some embodiments, the outer phase comprises water.

In certain embodiments, at least one of the two or more components comprises a deuterated compound (e.g., a deuterated hydrocarbon, a deuterated fluorocarbon). Droplets having components comprising deuterated compounds may be useful in various applications including, for example, NMR and MRI.

In some embodiments, at least one of the two or more components comprises a polymer (e.g., polyethylene glycol). In certain embodiments, the polymer is a block copolymer. In certain embodiments, the polymer is a liquid crystal polymer (e.g., a thermotropic liquid crystal polymer). In certain embodiments, the polymer is a biopolymer (e.g., gelatin, alginate). In some cases, the polymer may be transparent to a particular range of electromagnetic radiation (e.g., to visible light).

In some embodiments, at least one of the two or more components comprises a liquid crystal. Non limiting examples of liquid crystals include thermotropic liquid crystals (e.g. 4-Cyano-4′-pentylbiphenyl), lyotropic liquid crystals, and metallotropic liquid crystals (e.g. complexes of ZnCl₂).

In some embodiments, at least one of the two or more components comprises a gas.

Non-limiting examples of combinations of components present in the plurality of droplets described herein include hexane and perfluorohexane, carbon tetrachloride and perfluorohexane, chloroform and perfluorohexane, hexane and perfluorodecalin, hexane and perfluoromethylcyclohexane, hexane and perfluorotributylamine, isopropanol and hexadecane, ethyl lactate and heptane, acetic acid and decane, and triethylamine and water. Other combinations and materials are also possible.

In some embodiments, at least one of the two or more components comprises a combination of the materials described above (e.g., comprising a hydrocarbon, a fluorocarbon, a silicone, or combinations thereof). In some embodiments, a first component may comprise at least two miscible compounds (e.g., or two compounds at a temperature at which the compounds are miscible), both or all of which may be immiscible with a second component (e.g., the first component comprises a mixture of hydrocarbons and the second component comprises a fluorocarbon).

In some embodiments, one or more components and/or the outer phase comprises an additional compound dispersed in the one or more components and/or the outer phase. In certain embodiments, the additional compound is dispersible in a first component and not dispersible in a second component. In some cases, at least a portion of the additional compound is dispersible in the first component and not dispersible in the second component (e.g., a surfactant). In some embodiments, the additional compound may be dispersible or not dispersible in the outer phase. Non-limiting examples of suitable additional compounds include particles (e.g., magnetic particles/nanoparticles, silica particles), biological molecules (e.g., insulin), pharmaceutical compounds, polymers, surfactants, cells, bacteria, viruses, active pharmaceutical ingredients, and metals or metal particles. Other additional compounds are also possible and those skilled in the art would be capable of selecting such compounds based upon the teachings of this specification.

Those skilled in the art would be capable of selecting suitable components such that the components have a first configuration (i.e. arrangement) in the absence of a stimulus and a second configuration (i.e. arrangement) in the presence of the stimulus. In some embodiments, the components have a first configuration (i.e. arrangement) in the presence of a first stimulus and a second configuration (i.e. arrangement) in the presence of a second stimulus.

The outer phase may comprise any suitable material. In some embodiments, the outer phase is a solid. In certain embodiments, the outer phase is a liquid. In some embodiments, the outer phase is a gel. Generally, the two or more components comprising the plurality of droplets may be substantially immiscible with the outer phase. In some embodiments, the outer phase is an aqueous phase (e.g., comprising water, a hydrocarbon, a fluorocarbon). In certain embodiments, the outer phase is a non-aqueous phase (e.g., comprising a silicone, comprising a polymer, comprising an elastomer, comprising a glass). In an exemplary embodiment, the outer phase is a polymer. In another exemplary embodiment, the outer phase is an elastomer. In yet another exemplary embodiment, the outer phase is a glass. In some embodiments, the non-aqueous phase comprises a hydrocarbon, a fluorocarbon, a silicone, or the like, as described above in the context of the two or more components, and is substantially immiscible with at least one of the two or more components. The use of a non-aqueous outer phase may be advantageous in certain applications including, but not limited to, tunable lenses.

Those skilled in the art would be capable, based upon the teachings of the specification and the examples below, of selecting suitable materials for use as an outer phase based upon the miscibility of those materials (e.g., such that the two or more components may be substantially immiscible with the outer phase). In some embodiments, the article comprises a plurality of droplets dispersed in the outer phase wherein the outer phase is a liquid (e.g., a liquid polymer, a gel precursor) and is solidified (e.g., polymerized) or gelled (e.g., crosslinked). Those skilled in the art would be capable of selecting suitable methods for solidifying or gelling the outer phase.

In some embodiments, the outer phase is transparent (e.g., to a particular wavelength of electromagnetic radiation such as visible light) such that a particular wavelength of electromagnetic radiation (e.g., visible light) may be transmitted through the outer phase and interact with the plurality of droplets described herein.

In certain embodiments, an article comprising a plurality of droplets having two or more components may be formed. In some such embodiments, the article may be stimulated such that the radius of curvature between two components and/or the average focal length of the droplet changes. After stimulating, the outer phase may be solidified (e.g., polymerized, gelled, or the like) such that the change in radius of curvature and/or average focal length is maintained. In certain embodiments, the plurality of droplets may be stimulated after solidification of the outer phase such that two or more components in at least a portion of the plurality of droplets obtain a new configuration.

In some embodiments, the article further comprises an additional compound such as an amphiphilic compound. In certain embodiments, the amphiphilic compound is miscible in the outer phase. In some embodiments, the amphiphilic compound is miscible in at least one of the two or more components. In certain embodiments, the amphiphilic compound has a greater miscibility in at least one of the two or more components than a miscibility in the outer phase. In some embodiments, the amphiphilic compound is dispersed at the interface between the outer phase and the plurality of droplets. In certain embodiments, the amphiphilic compound is dispersed at the interface between at least two of the two or more components. The amphiphilic compound may preferentially interact with one or more components or the outer phase. Those skilled in the art would be capable of selecting a suitable amphiphilic compound based upon the teachings of the specification and examples below. Miscibility may be determined, for example, as described above using an inverted pendant drop goniometer.

In some embodiments, the amphiphilic compound is a surfactant. Non-limiting examples of suitable surfactants include fluorosurfactants (e.g., commercially available fluorosurfactants such as Zonyl® or Capstone®), anionic surfactants (e.g., sodium dodecyl sulfate (SDS)), cationic surfactants (e.g., alkyltrimethyl ammonium chloride, alkylmethyl ammonium bromide), non-ionic surfactants (e.g., alkyl poly(ethylene oxide)), zwitterionic surfactants (e.g., alkyl betain, C₈-lecitin), polymeric surfactants, gemini surfactants, particulate surfactants (e.g., graphene oxide, silica particles), and combinations thereof. Other surfactants are also possible.

In some embodiments, the amphiphilic compound is a nucleic acid (e.g., DNA, RNA). In certain embodiments the amphiphilic compound comprises an amino acid (e.g., a peptide, a protein). In some embodiments, the amphiphilic compound comprises a biomaterial. Non-limiting examples of suitable biomaterials include carbohydrates or derivatives thereof, saccharides or derivatives thereof (e.g., sialic acid), lipids or derivatives thereof, enzymes, chromophores or the like. Those skilled in the art would be capable of selecting suitable biomaterials based upon the teachings of the specification and the examples below.

In some embodiments, the amphiphilic compound comprises a perfluorinated segment. In some embodiments, the amphiphilic compound comprises ethylene glycol.

In some embodiments, the amphiphilic compound is capable of forming metal complexes.

In certain embodiments, the amphiphilic compound is graphene oxide.

In some embodiments, the amphiphilic compound may be a particle (e.g., a silica particle, a polymer particle, a Janus particle, a nanoparticle, a gel particle).

In some embodiments, the amphiphilic compound is added to an article (e.g., a article comprising an outer phase and a plurality of droplets comprising two or more components, dispersed within the outer phase). In some such embodiments, the amphiphilic compound may act as a stimulus.

The term stimulating as used herein generally refers to the addition, removal, or change of a condition, a compound, or the environment (e.g., temperature, pressure, pH) such that the radius of curvature between two or more components is changed and/or the average focal length of the droplet is changed. Those skilled in the art will be capable of selecting suitable stimulus for use with the article described herein based upon the teachings of the specification and will understand stimulation does not comprise substantially removing a component and/or replacing the entirety of a component with a new component. However, in some embodiments, stimulating the article may result in a component, additional compound, and/or surfactant present in the article changing molecular conformation such that the component, additional compound, and/or amphiphilic compound is chemically distinguishable after stimulation (e.g., an acid cleavable component, additional compound, and/or amphiphilic compound that cleaves in the presence of an acid, a photosensitive component, additional compound, and/or amphiphilic compound that changes conformation or molecular structure after exposure to light) as compared to before stimulation.

In some embodiments, stimulating the article comprises exposing the colloid to an external stimulus (e.g., such that the radius of curvature between two or more components is changed). In some cases, the external stimulus may comprises electromagnetic radiation, ionizing radiation, a magnetic field, an electric field, a mechanical force (e.g., pressure, direct contact), or combinations thereof. Those skilled in the art would be capable of selecting suitable components and methods of applying such external stimuli based upon the teachings of the specification and examples below.

For example, in some such embodiments, at least one of the two or more components may comprise a magnetic particle such that, in the presence of a magnetic field, the at least one of the two or more components transposes or changes configuration with at least one additional component of the two or more components.

In certain embodiments, the external stimulus comprises photochemical stimulation (e.g., exposing the article comprising a plurality of droplets to light). The light may comprise any suitable wavelength, including but not limited to radio waves (e.g., a wavelength between about 1 cm and about 100 m), infrared light (e.g., a wavelength between about 700 nm and about 1 cm), visible light (e.g., a wavelength between about 400 nm and about 700 nm), ultraviolet (UV) light (e.g., a wavelength between about 10 nm and about 400 nm), and x-rays (e.g., a wavelength between about 0.01 nm and about 10 nm).

In some embodiments, stimulating the article comprises changing the temperature of the colloid (e.g., such that the radius of curvature between two or more components is changed and/or the average focal length of the droplet is changed). In certain embodiments, changing the temperature of the article comprises heating the article. In some embodiments, changing the temperature of the article comprises cooling the article. Those skilled in the art would be capable of selecting suitable methods of heating or cooling the article based upon the teaching of the specification and examples below. In some embodiments, stimulating the article comprises local generation of heat in the vicinity of the article, for instance using an infra-red laser or any other laser with a wavelength that is partially absorbed in the surrounding medium.

In certain embodiments, stimulating the article comprises applying a force and/or pressure to the article such that the radius of curvature between two or more components is changed and/or the average focal length of the droplet is changed.

In some embodiments, stimulating the article comprises adjusting the ionic strength and/or adjusting the pH of the outer phase. For example, in some embodiments, adjusting the pH of the outer phase comprises adding an acid (e.g., HCl) or a base (e.g., NaOH). For example, in some such embodiments, at least one of the two or more components comprises a pH-sensitive surfactant (e.g., N-dodecylpropane-1,3-diamine) and/or an acid-cleavable surfactant (e.g., sodium 2,2-bis(hexyloxy)propyl sulfate) such that the pH-sensitive surfactant and/or the acid-cleavable surfactant changes charge and/or cleaves in the presence of an acid or a base, such that the radius of curvature between two components is changed and/or the average focal length of the droplet is changed.

In certain embodiments, stimulating the article comprises adding an analyte to the article. The analyte may comprise any suitable material (e.g., a vapor analyte, a liquid analyte, a solid analyte) such that the incorporation of the analyte into a portion of the plurality of droplets or the outer phase causes the two or more components to change the radius of curvature and/or causes the droplet to change the average focal length. Those skilled in the art would be capable of selecting analytes and components suitable for article based upon the teaching of the specification and the examples below. Non-limiting examples of suitable analytes includes a biological compound, a drug, a macromolecule, a salt, an electrolyte, an enzyme, a nucleic acid, a carbohydrate, a peptide, a protein, a lipid, a phosphate, a sulfonate, a virus, a pathogen, an oxidant, a reductant, a toxin, a chemical warfare agent, an explosive, carbon dioxide, a surfactant, or combinations thereof.

Article described herein may be formed using any suitable method. For example, in some embodiments, an outer phase material, a first component, and a second component are mixed and emulsified, forming an outer phase and a plurality of droplets in the outer phase having a first component and a second component at least partially encapsulated by the first component. Suitable methods for emulsifying the fluid are known in the art and may comprise sonication, high shear mixing, shaking, passing the fluid through a membrane, or injecting the two or more components into the outer phase through a small diameter channel (e.g., a microchannel(s)).

In certain embodiments, the outer phase material, the first component, and the second component may be mixed at a temperature at which the first component material and the second component material are miscible. In some such embodiments, the temperature of the mixture may be changed (e.g., increased, decreased) to a temperature such that the first component and the second component are immiscible and form a plurality of droplets in the outer phase having a first component and a second component at least partially encapsulated by the first component. While much of the description herein applies to two components, those skilled in the art would understand that such methods may be useful for the formation of colloids comprising a plurality of droplets having three or more, four or more, or five or more components. Additional suitable methods for forming articles comprising a plurality of droplets are described, for example, in co-owned U.S. Patent Publication Number 2016/0151753, entitled “Compositions and Methods for Forming Emulsions”, filed Oct. 30, 2015; and in co-owned U.S. Patent Publication Number 2016/0151756, entitled “Compositions and Methods for Arranging Colloid Phases”, filed Oct. 30, 2015, each of which is incorporated herein by reference in its entirety.

U.S. Provisional Application Ser. No. 62/454,663, filed Feb. 3, 2017, entitled “Tunable Microlenses And Related Methods”, is also incorporated herein by reference in its entirety for all purposes.

The articles described herein may be used, for example, in a device such as an optical imaging system, a miniaturized optical imaging system, a miniaturized tomographic imaging system for 3D image acquisition, a miniaturized integral imaging device, an optical image projecting system, and/or an auto-stereoscopic display. The device may comprise a plurality of droplets arranged to create a responsive, reconfigurable illumination source. Advantageously, articles described herein may alleviate the need of mechanical focusing to be employed in, for example, devices such as ophthalmology instruments and/or endoscopes.

As used herein, a “fluid” is given its ordinary meaning, i.e., a liquid or a gas. A fluid cannot maintain a defined shape and will flow during an observable time frame to fill the container in which it is put. Thus, the fluid may have any suitable viscosity that permits flow. If two or more fluids are present, each fluid may be independently selected among essentially any fluids (liquids, gases, and the like) by those of ordinary skill in the art.

### EXAMPLES

The following examples illustrate embodiments of certain aspects of the invention. It should be understood that the methods and/or materials described herein may be modified and/or scaled, as known to those of ordinary skill in the art.

The following examples relate to the optical characteristics of a new generation of fluidic tunable compound micro-lenses. Exemplary compound micro-lenses were composed of hydrocarbon and fluorocarbon liquids that form stable bi-phase emulsion droplets in aqueous media. Combinations of transparent fluids Fluorinert FC-770 (n_{FC}=1.27) with heptane (n_{HP}=1.387), or hexane (n_{HX}=1.375) were used. The refractive index of the hydrocarbon constituent was higher than the refractive index of water (n_{W}=1.33), while the fluorinated component had a refractive index lower than that of water. The refractive index contrast at each material interface as well as the curvature of each interface contributes to the focusing power of a refractive optical element. Therefore, such fluid combinations could allow for a wide tuning range of the emulsion lenses' focal length, thereby enabling switching between converging or diverging lens geometries. The complex droplet lenses (e.g., lenses comprising a plurality of droplets) can be easily fabricated on a large scale using a temperature-induced phase separation technique appropriate for combinations of liquids having a relatively low upper critical solution temperature. Such complex droplets can also be dynamically reconfigured between double emulsion and Janus (two-sided) morphologies through application of external stimuli, which makes these droplets very promising as highly tunable compound lenses. The adjustability in focal length of the lenses as well as their microscopic and macroscopic light manipulation characteristics was demonstrated.

### Modeling of Emulsion Droplets as Tunable Lenses

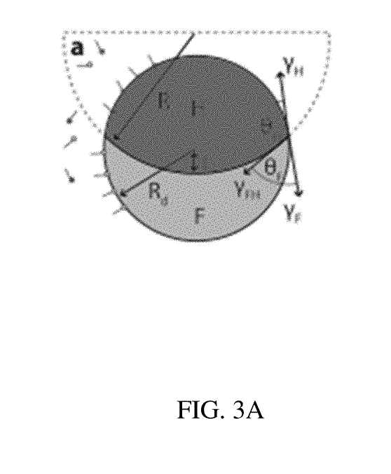

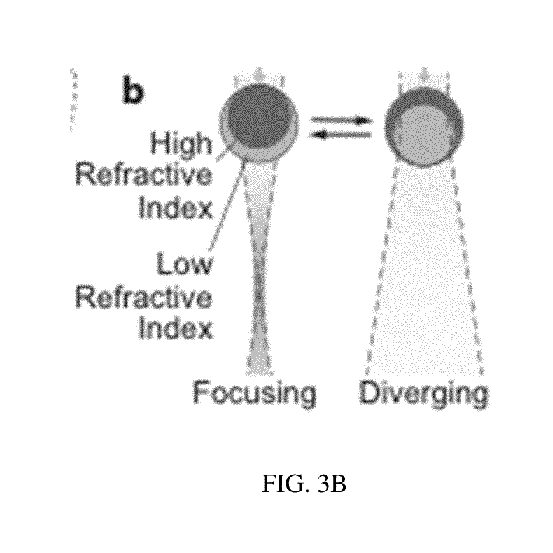

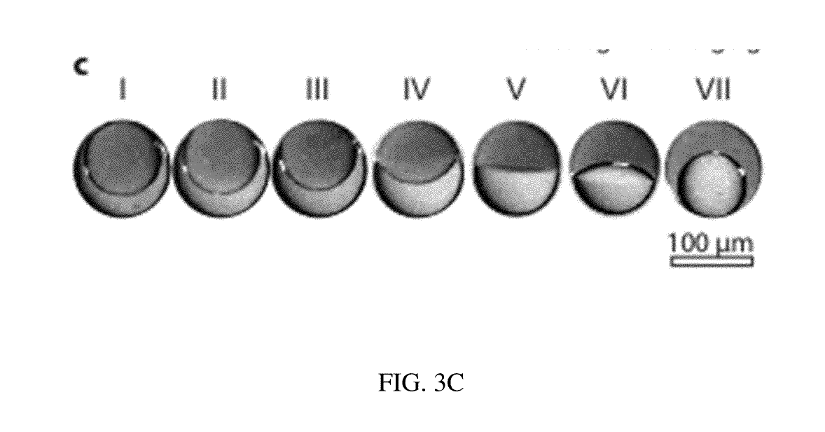

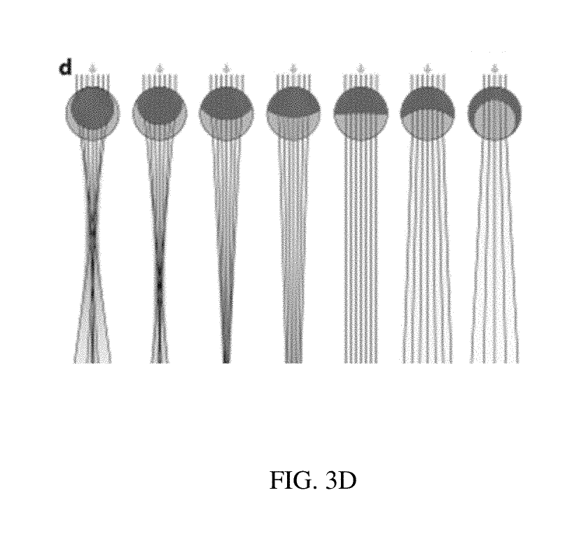

For these particular exemplary emulsions, the curvature of the internal interface formed between the immiscible phases can be adjusted using surfactants that modify the relative interfacial tensions between the droplet phases and water. Surfactant-mediated modification of interfacial tensions resulted in a variation of the contact angles at the triple-phase contact line. This relates the radius of curvature of the lenses' internal interface, which in turn affects the optical properties of the droplets (FIGS. 3A-3B). To demonstrate how the controlled, dynamic variation of the complex droplets' geometry could induce a tunable interaction with light, a ray-tracing algorithm was implemented in MATLAB. The overall droplet shape was assumed to be spherical, which is an appropriate approximation when the interfacial tension between the droplet phases is much smaller than the interfacial tensions between the droplet constituents and the aqueous medium (FIG. 3A). This was the case for working temperatures close to the critical temperature of the internal fluids. For the droplet diameters on the order of 100 μm discussed here, the internal interface can be considered to be spherical, since the ratio of gravitational to surface tension forces is relatively small. Under these assumptions, the distance l of the interface from the center of the overall drop is given by

$${( {R}_{d} - l )}^{2} ( {l}^{2} + 4 {R}_{i} {R}_{d} + 2 {R}_{d} l - 3 {R}_{i} l - 3 {R}_{d}^{2} ) + \frac{16 {R}_{d} ( {R}_{i} - l )}{1 + {v}_{r}} = 0 , \qquad ( 1 )$$

where R_{d} is the radius of the drop, Rᵢ is the internal radius of curvature (i.e. the radius of curvature of the interface between the first component and the second component), and vᵣ is the volume ratio of the internal droplet phase to the outer droplet phase. The internal curvature is set by the balance of interfacial tensions at the triple-phase contact line⁴⁷ given by

$$\frac{{γ}_{H} - {γ}_{F}}{{γ}_{H F}} = ( {R}_{d}^{2} + 2 {R}_{i} l - {l}^{2} ) / ( 2 {R}_{i} {R}_{d} ) . \qquad ( 2 )$$

When the optical axis is aligned with the droplets' symmetry axis, the optical system is axisymmetric and can be modeled in two dimensions. The droplets' symmetry axis aligns with the gravitational field due to the difference in density between the light hydrocarbon phase and the dense fluorocarbon phase. This alignment was exploited in the theoretical and experimental study of the droplets' optical characteristics. The ray-tracing calculations predicted that the double emulsion droplets with a high refractive index core phase and a lower refractive index shell phase can focus light, while an inversion of this droplet geometry results in diverging lenses (FIG. 3B-3D). By adjusting the droplets' internal interface curvature, each droplet can be tuned between a converging lens with varying positive optical power and a diverging lens with varying negative optical power.

3D Focus Scans Behind Droplets with Varying Morphology

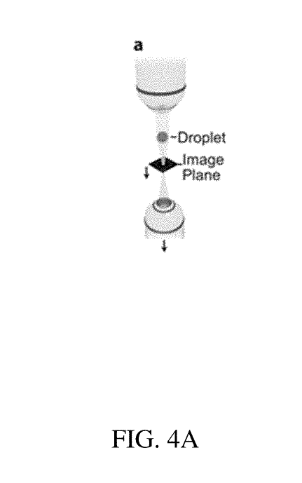

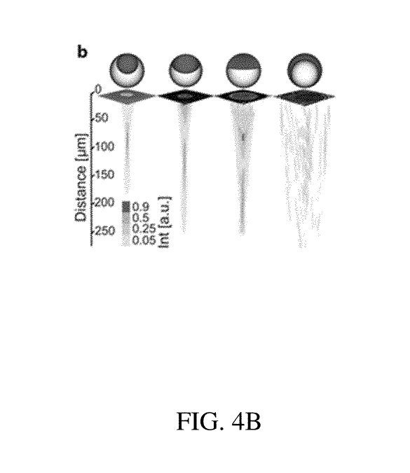

The interfacial tensions that determine the droplet morphology can be tailored by controlling, for example, the concentration and ratio of surfactant species added to the aqueous phase. In these experiments, a combination of both a hydrocarbon-stabilizing surfactant, such as sodium dodecyl sulfate (SDS), and a fluorocarbon-stabilizing surfactant, such as Zonyl FS-300 or Capstone FS-30, were used. In order to map the light field behind heptane—FC-770 droplets, the droplets were illuminated with a collimated beam of quasi-monochromatic light of a 540 nm wavelength, and the light field in the volume behind the droplets was recorded by scanning the image plane of an inverted microscope (FIG. 4A). Variation in the concentrations of SDS and Capstone FS-30 in the surfactant mixture added to the aqueous phase allowed for alteration of the droplets' internal interface curvature (e.g., the radius of curvature between two immiscible components in the droplet) resulting in a variation of their focal length (FIG. 4B).

### Quantification of the Droplet Lenses' Optical Characteristics

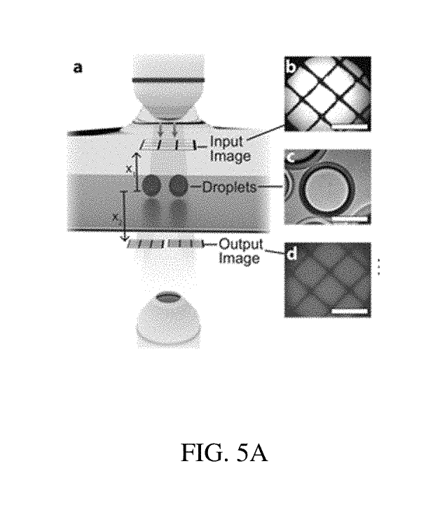

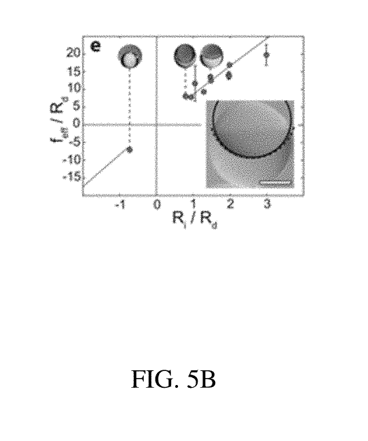

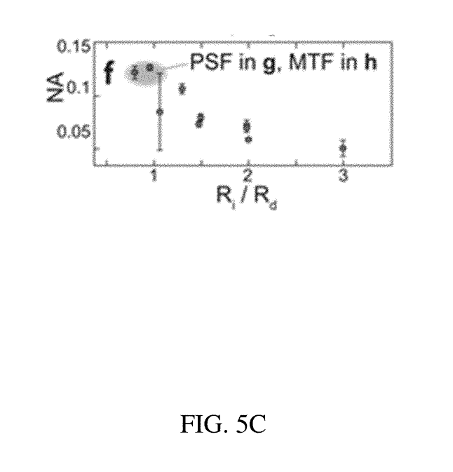

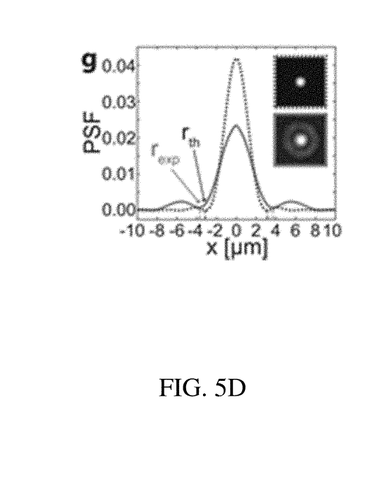

The native function of a lens is generally to form an image. In order to evaluate the image formation capabilities of the droplets, including experimentally quantifying their optical power, an object was placed in front of the droplets and used them to project an image at varying distances (FIG. 5A). Specifically, a grid pattern was projected in the aqueous medium above the droplets. The image of the object formed by the droplets was recorded using an inverted microscope. By varying the concentrations of SDS and Zonyl surfactant in the aqueous medium surrounding the droplets (e.g., stimulating the droplets by adjusting the concentration of the surfactant in the outer phase), the internal interface shape could be adjusted. By projecting the image of an object through the lenses and by measuring object-to-lens and lens-to-image distances (FIGS. 5A-5D), the micro-lenses' effective focal length was quantified.

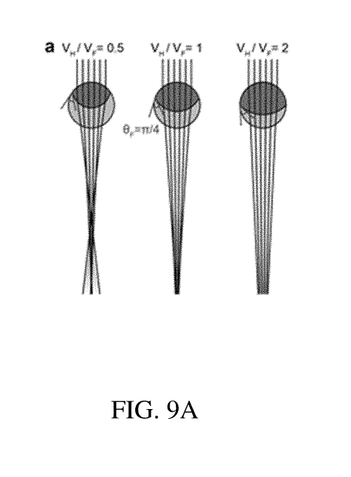

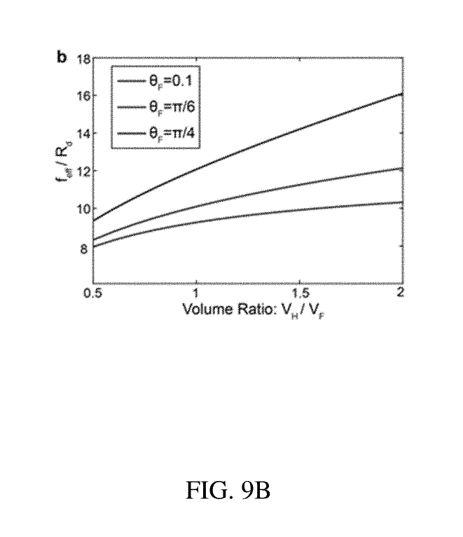

The internal interface curvature of the droplets was determined by fitting a circle to the interface shape observed in side-view micrographs (FIG. 5E, inset), taking into account refraction due to the outer droplet phase. Knowing this curvature, the expected effective focal length acquired using the paraxial approximation and the ray transfer matrix calculations could be compared with the experimentally determined effective focal length (FIG. 5E). It was found that FC-770-heptane droplets formed with volume ratio 1:1 can vary in focal length from 3.5 times the diameter of the droplet to infinity, and can switch between positive and negative focal lengths. For example, a double emulsion droplet of 100 μm diameter, with heptane as the core phase and the fluorocarbon FC-770 as the shell phase, had a focal length of 350 μm and acted as a converging lens. While the experiments presented here were restricted to lenses with constant volume ratio of 1:1, a variation in volume ratio was observed to result in a change in radius of curvature of the internal interface and consequently in changes of the lenses' focal length provided that the triple phase contact angles are kept relatively constant. Raytracing results of droplets with constant contact angle and varying volume ratio can be seen in FIGS. 9A-9B. This additional degree of freedom suggests interesting future perspectives for multi-fluid lens optical systems, especially in terms of higher order aberration correction.

The configuration of the droplet in FIG. 3C (V) is a special case where the droplets have an effective focal length of infinity. For the FC-770-heptane emulsions, this occurs when the interface is nearly flat; the refraction at the water-heptane interface is effectively cancelled by a compensating refraction at the FC-770-water interface. The lenses' numerical aperture, given by

$$N A = n sin ( {tan}^{- 1} \frac{D}{2 f} ) ,$$

generally decreases with increasing focal length. Here n=1, since the image was formed in air beneath the droplet lenses, which were positioned on top of a glass coverslip.

To estimate the droplet lenses' optical quality, two metrics used in the design of lenses were utilized: First, the two-point resolution criterion postulated by Rayleigh in 1896 generally provides a measure for the minimum distance between two object points for which these two points can still be distinguished unambiguously in the image projected by a lens. Second, the Abbe diffraction limit generally defines the maximum spatial frequency of a sinusoidally varying intensity pattern that can be resolved with sufficient contrast by the lens. The standard definition of the Rayleigh two-point resolution criterion were applied, which consists of determining the distance from the center of the lenses' point spread function (PSF) to its first minimum. With this definition, the theoretically achievable resolution rₜₕ of a diffraction-limited lens is given by

$${r}_{th} = 1.22 \cdot \frac{λ}{2 N A} .$$

The PSF of droplets was experimentally determined by imaging the focus formed by droplets that were illuminated with collimated light. A white light source was used but only the image information of the camera's red channel was utilized (with maximum quantum efficiency at 620 nm). The experiment was performed with droplets with a highly curved internal interface. From the experimental PSF estimate the droplets were found to resolve details down to a feature size of rₑₓₚ=3.7 μm. The theoretical two-point resolution limit of a comparable diffraction limited lens is generally rₜₕ=3.1 μm. An estimate of the Modulation Transfer Function (MTF) of the same droplets based on the experimentally obtained PSF estimate was also determined. The MTF's cut-off frequency at a remaining image contrast of at least 10% of the original object contrast was found to be fₑₓₚ^{10%}=0.22 cycles per μm, which corresponds to a sinusoidal intensity variation of 4.5 μm period. The theoretical line pattern resolution limit for a comparable lens is 3.2 μm (fₜₕ^{10%}=0.31 cycles per μm). The discrepancy between the measured and the theoretical resolution limits may be due to spherical aberrations.

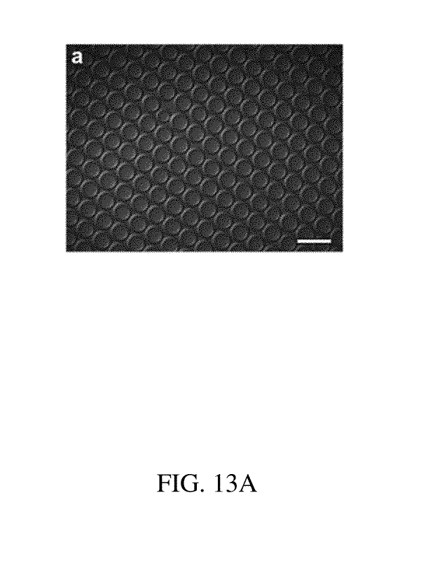

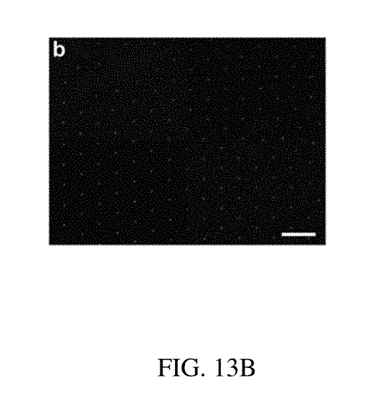

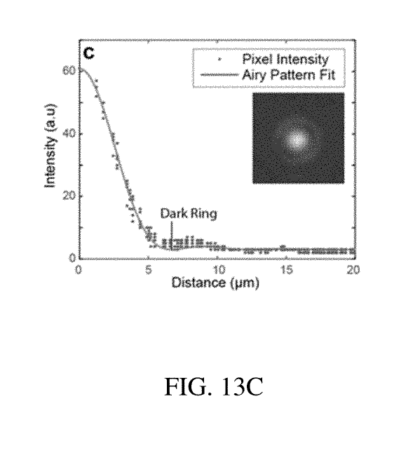

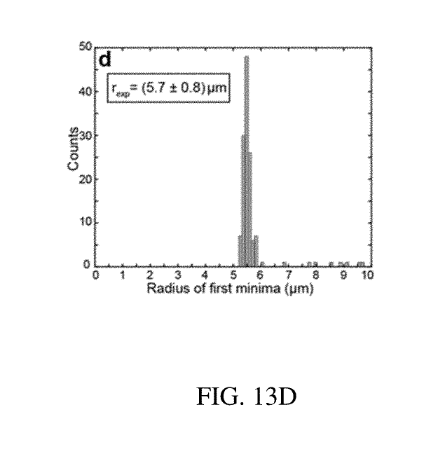

Using micro-fluidics, emulsion lenses with a highly uniform size distribution were produced (see FIGS. 13A-13D). Droplets of the same size, with the same volume ratio and matching internal interface curvature, generally have matching focal lengths. FIGS. 13B-13D demonstrate that when light is focused through several lenses of the same size, all point spread functions generally have similar shapes, and thus very similar focal lengths, and numerical apertures.

### Potential Applications of Tunable Droplet Compound Lenses

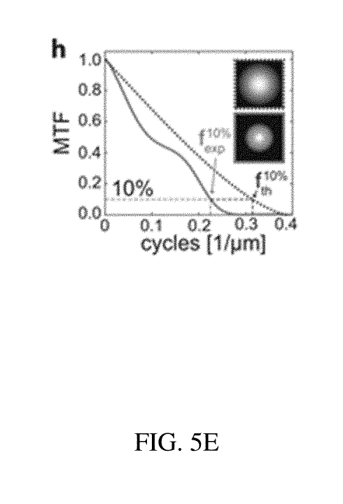

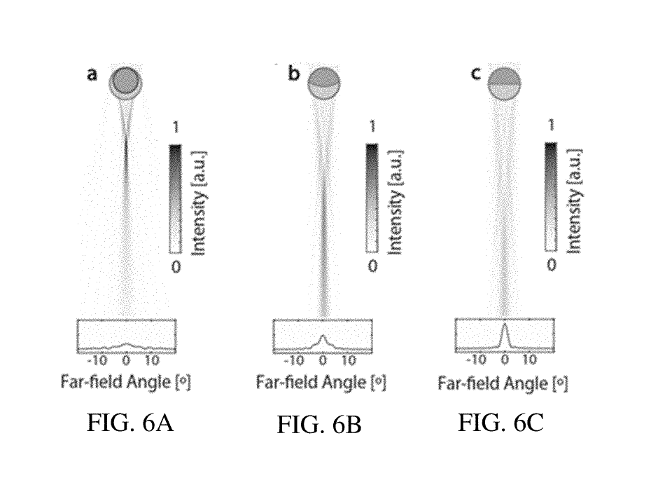

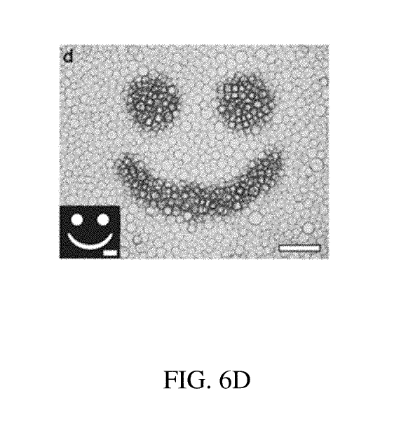

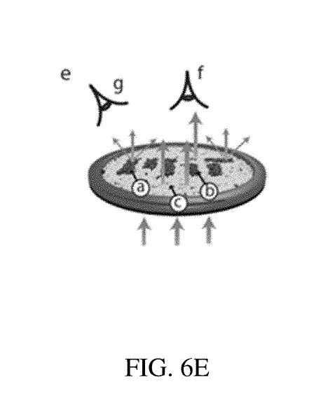

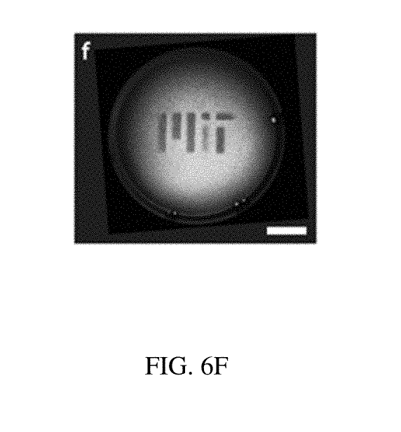

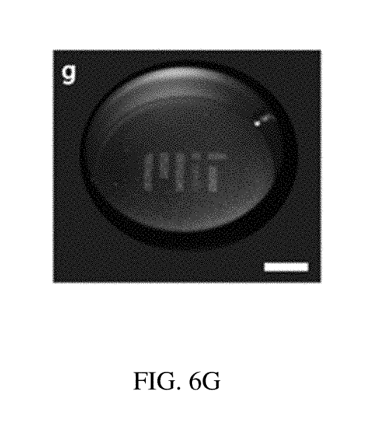

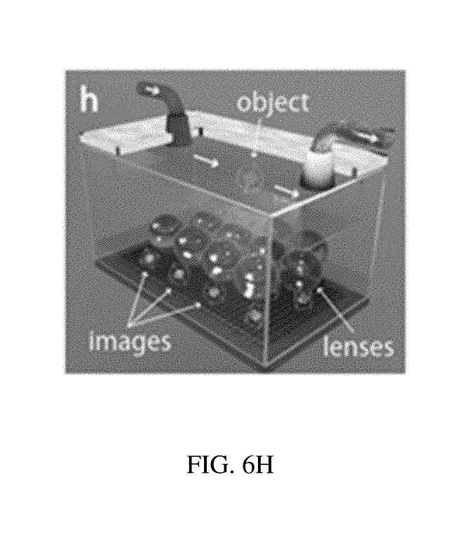

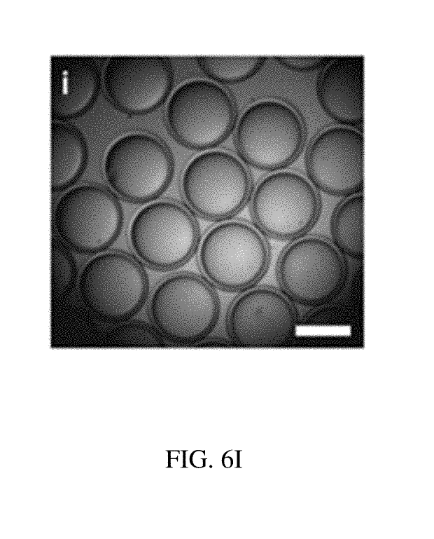

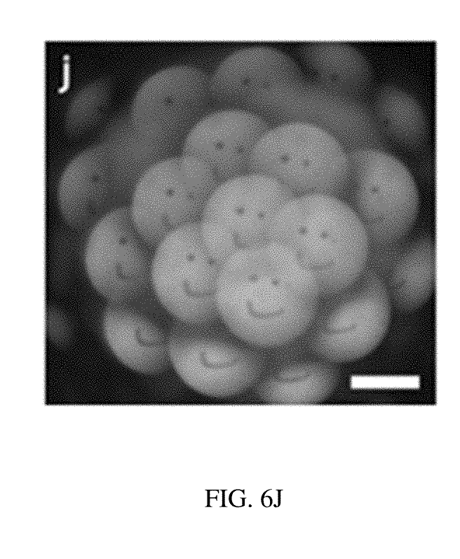

To explore potential application scenarios, the micro-scale optical tunability of the droplets was determined if it could be translated to observable differences in macroscopic properties. In the case of a strongly focusing double emulsion, finite difference time domain (FDTD) simulations show that a single droplet may scatter light in a cone with an opening angle of almost 30°. On the other hand, a Janus droplet with a nearly flat interface transmits light with an angular spread of only a few degrees. To test whether this phenomenon could be observed to create droplet-based displays, films of polydisperse emulsion droplets were formed covering an area of several cm². In order to induce localized variations in droplet morphology, an optically switchable azobenzene surfactant was employed to change the morphology of the emulsions droplets. Irradiation of selected areas of droplets with UV light using a “smiley face” photomask, induces a transformation of the exposed droplets from the transparent Janus geometry to a strongly scattering double emulsion geometry. Simple visual inspection reveals a clear optical contrast when viewed in transmission (FIGS. 6A-6B). Exposure to UV radiation and blue light allowed for reversibly switching the compound lenses between these two morphologies again and again, without any signs of degradation

The FDTD simulations predicted that droplets with an internal curvature somewhere between the extremes of the double emulsion state and the flat-interface Janus configuration scatter light in a cone with an opening angle larger than that of the Janus droplets, but smaller than that of the double emulsions (FIG. 6A). Whether these optical differences could create surfaces with controlled spatial variation in perceived brightness was tested (FIG. 6C) by finely adjusting the droplet's internal curvature through careful tuning of the UV light exposure. To this end, a droplet assembly was irradiated through a MIT photomask in which a piece of scattering Scotch tape was placed over the stem of the “i” to partially block UV transmission. A significant decrease in pattern brightness was observed in the modified photomask region of the sample when observed in direct transmission (FIG. 6D). Without wishing to be bound by theory, the double emulsions scatter light into a larger angular range; consequently, when the same sample is viewed at an angle, the areas that were exposed to the UV radiation appeared brighter. Hence, an inversion of the image (FIG. 6E) was observed, consistent with FDTD simulations. In short, image contrast in the droplet films can be varied by photo-chemically modulating (e.g., stimulating) the degree of curvature of the droplets' internal interface.

The droplets' variable focal length and their capability to form images are properties that are particularly relevant for a variety of application scenarios related to miniaturized imaging devices. Arrays of micro-lenses, for example, find application in digital integral microscopic imaging and photography. One of the main challenges in three-dimensional image acquisition is the limited depth of field. The tunable focal length lenses could provide the means to address this limit. To evaluate whether the lenses could be considered for integral imaging applications, monodisperse bi-phase double emulsion droplets were produced and arranged them in a close-packed monolayer. In such a multi-lens arrangement, each lens projected a plane elemental image of an object at slightly different angles (FIGS. 6F-6H). Therefore, each lens had a different perspective of an imaged 3D object. Computational recombination of the images from multiple lenses should then allow for the capturing the three-dimensional forms of imaged objects.

Complex emulsions of optically distinct, immiscible hydrocarbons and fluorocarbons in aqueous media were shown to form droplets that act as compound lenses with a tunable droplet-internal optical interface. Adjustment of the droplet's interfacial tensions with the aqueous phase allowed for a continuous and reversible variation from double emulsions, through Janus configurations, to inverted double emulsions. Depending on their configuration, the droplets showed different interactions with light. Double emulsions with the optically denser fluid as the droplet-core phase strongly focused light. Janus droplets did not significantly disturb the light wavefront, when the surface normal of the internal interface is aligned with the light propagation direction. Double emulsions with the optically denser fluid as the droplet-shell phase show strong light scattering. A controlled modification of the droplet morphology consequently resulted in a predictable variation of the droplets' light focusing and scattering behavior.

Depending on their morphology, the droplets can act as converging lenses projecting real inverted images, or as diverging lenses forming virtual upright images. These emulsion-based micro-lens droplets had a dynamically tunable focal length that can vary from ±3.5× the drop diameter to ±infinity. With a resolution limit around 4 μm, the reconfigurable micro-lenses did not show diffraction-limited performance (resolution limit of 3 μm for a comparable diffraction-limited micro-lens), which was attributed to the presence of spherical aberrations. Such microscopic droplet compound lenses have clear advantages in applications where device size, simplicity, and the ability to reconfigure on-demand matters; this could be of particular interest in synthetic aperture integral imaging where in-situ reconfigurable optical components could help to enhance performance of the imaging device. Liquid lenses with variable focal length could form the basis of adaptive micro-scale optical elements in miniaturized integral 3D imaging and sensing devices.

Such tunable droplet micro-lenses exhibit differences in their macro-scale optical appearance, which can be used for the creation of patterns and images. Light scattering is generally more pronounced for droplets in the double emulsion geometry, while droplets with a flat internal interface induce much smaller perturbations in the propagating light wavefront. This allows for the creation of microscopic and macroscopic patterns with tunable contrast, which could form the basis for light field displays capable of creating 3D images and projecting variable information content into different directions.

Using halogenated liquids with high refractive index as constituents of the emulsion droplets could enable the formation of compound lenses with higher refractive power. This additional degree of freedom—the choice of emulsion formulation—could be used for correcting aberrations or for introducing a desired chromaticity. Incorporation of active optical media, plasmonic elements, or magnetic nanoparticles may open up a broad parameter space for tuning and controlling the fluid micro-lenses' dynamical optical properties, and simultaneously provide access to a multitude of enticing sensing paradigms and optical applications.

### Methods

### Droplet Formation

Double emulsion droplets were formed using a 1:1 volume ratio of heptane and Fluorinert FC-770 for the lensing experiments and a 1:1 volume ratio of (2:1 hexane:heptane) to FC-770 for the UV switchable droplets. For each of the two material combinations, the two fluids were combined in equal volumes and heated to just above the suspension's upper critical solution temperature T_{c} to allow the two liquids to form a homogeneous mixture. An aqueous surfactant solution heated above T_{c} was then added, and the resulting mixture was quickly shaken to form small multi-disperse droplets, which were left to cool to allow the constituent oils to phase separate. Mono-disperse droplets were formed in a glass capillary microfluidic device that consists of an outer square capillary (outer diameter, 1.5 mm, inner diameter, 1.05 mm, AIT Glass), and an inner cylindrical capillary (outer diameter, 1 mm, World Precision Instruments). The capillary assembly was pulled to form a 30 μm tip using a P-1000 Micropipette Puller (Sutter Instrument Company). Harvard Apparatus PHD Ultra syringe pumps were used to inject the homogenous mixture of fluorocarbon and hydrocarbon into the inner capillary and aqueous surfactant solution into the outer capillary. The microfluidic device and syringe pumps were maintained at a temperature above T_{c} using a heat lamp while the drops were formed, and the drops were then cooled below T_{c} to induce phase separation. The droplets were found to be stable on the timescale of several days, at least. It was believed that the droplets would stay stable for much longer, provided the aqueous medium and sample environment are optimized (see Supplementary Note 5, and Supplementary FIG. 6).

### Determining the Curvature of the Internal Interface

The curvature of the internal interface between the droplets' hydrocarbon and fluorocarbon phases was determined with a custom-built microscope with horizontal axis that allowed capturing side views of the droplets. For these experiments, the droplets were placed onto a hydrogel substrate enclosed between two coverslips. The microscope consists of an Olympus 5× objective (NA=0.15), a Thorlabs tube lens (effective focal length=200 mm), and an OMAX 14.0 MP Digital USB Microscope camera. A white screen was placed behind the sample, and the sample was illuminated from the side using a Fiber-Lite MI-152 lamp.

When viewing the internal interface between the fluorocarbon phase and the hydrocarbon phase, the image was distorted generally due to the curved outer phase. This distortion due to refraction at the droplet's outer surface was accounted for when determining the location and curvature of the droplet-internal interface. Therefore, the following correction was applied to find the position of an object—in this case a point on the internal interface—within a droplet of refractive index n₁ that is located in a medium with refractive index n₂: if the object is located at a distance h measured perpendicular to the optical axis, which passes the center of a sphere of radius R, the height of its image hᵢ is given by the paraxial approximation:

$${h}_{i} = h \frac{{n}_{1}}{{n}_{2}} \qquad ( 3 )$$

This implies that the actual height h of an object in the droplet that appears to have a height hᵢ may be:

$$h ( {h}_{i} ) = {h}_{i} \frac{{n}_{2}}{{n}_{1}} \qquad ( 4 )$$

To deduce the actual droplet-internal interface location, this correction was applied by first determining the off axis distance hᵢ for each point along the interface in the side view images of the drops using a custom MATLAB algorithm. Equation (4) was then used to calculate the real shape of the internal interface by fitting a circle to this corrected curve to determine the interface curvature.

### Focus Scans

A custom-build microscope was used to reconstruct the light field behind the lenses. For this experiment, the drops were illuminated with a quasi-monochromatic plane wave. This was achieved by imaging the output of an optical fiber with 50 μm core in the back focal plane of a NPL 20× objective (Leitz Wetzlar, NA=0.45) used as a condenser. A 540 nm bandpass filter with an 80 nm bandwidth was used to create quasi-monochromatic light. The light field behind the droplets was captured by scanning the focal plane in 5 μm steps using a Madcity Labs micro-stage, a 20× Olympus objective (NA=0.75), a 200 mm focal length achromatic doublet tube lens, and an Andor Zyla sCMOS 5.5 Camera. The light field data was analyzed using MATLAB and ImageJ. The location and size of the droplets were determined from the images using ImageJ's measurement tools. The data from the focal scans was then entered into MATLAB to reconstruct the 3D light field behind individual droplet lenses, similar to the approach previously used to measure the light field behind retinal cell nuclei. After the light field was measured, the droplet lenses were placed in a microscope with horizontal optical axis and imaged from the side. This side view was used to determine the curvature and volume ratio of the drops.

### Measuring Droplets' Focal Length

In order to quantify the image formation characteristics of the droplets, an image of a grid pattern was projected in front of them using a 60× Olympus water dipping objective (NA=1.0). The droplets acting as lenses projected the object to form a new image, which was then recorded using a 10× objective (NA=0.3) with a customized microscope setup (FIG. 5A). The distance of the input image x₁ to a droplet lens can be controllably varied, and the position of the projected image behind the lens x₂ is determined by locating the plane, where the projected image is in focus (FIGS. 5B-5D). The location of the input and recorded images are related to the focal length by the simple lens relation

$$\frac{{n}_{c}}{{s}_{i}} + \frac{1}{{s}_{o}} = \frac{1}{f} ,$$

where sₒ and sᵢ are the distances from the input image to the first principle plane and from the second principle plane to the recorded image, respectively, and

$${n}_{c} = \frac{{n}_{{m}_{1}}}{{n}_{{m}_{2}}}$$

is the refractive index contrast between the surrounding media before and after the droplet lens (in the measurement setup m₁ was water and m₂ was air). The focal length and principle plane locations (p₁ and p₂) could then be determined by measuring the location of the output image for various input image locations and by using the relation

$$\frac{{n}_{water}}{{x}_{1} - {p}_{1}} + \frac{1}{{x}_{3} - {p}_{3}} = \frac{1}{f} , \qquad ( 5 )$$

where x₁−p₁=sᵢ, and x₂−p₂=sₒ.

### Determining the Droplets' PSF and MTF

The droplet lenses' point spread function (PSF) and modulation transfer function (MTF) provide quantitative measures of the two-point resolution and line pattern contrast limits that can be achieved when the lenses are employed in imaging applications. To get an estimate of the PSF, and MTF, individual droplets were exposed to white light, which originated from an optical fiber with a 50 μm diameter core and is collimated by a spherical lens (f=150 mm). The droplet's point spread function (PSF) was captured using a custom-build microscope composed of a 50× Olympus objective (NA=0.5), a Thorlabs tube lens (f=200 mm) and an Allied Vision ProSilica GT3300C camera. Only the camera's red channel was used (maximum quantum efficiency at 620 nm), expecting that the droplets' resolution would be at least comparable or better for smaller wavelengths. The MTF was obtained by Fourier-transforming the PSF after subtraction of background noise, removal of “salt and pepper” noise (due to hot pixels) using a median filter in a 3×3 pixel neighborhood area, and averaging over angular slices of the imaged Airy disk pattern.

### Using UV Light to Switch Lens Morphology

With a light-sensitive surfactant containing an azobenzene moiety, 3-(4-((4-butylphenyl)diazenyl)phenoxy)-N,N,N-trimethylpropan-1-aminium bromide, in the aqueous medium, the fluid lenses can be switched from a transparent Janus state to a scattering double emulsion state, and back, simply by exposure to light in the UV and blue spectral ranges. The droplets consisted of a 1:1 volume ratio of (2:1 hexane:heptane) to FC-770 and a 100 μl total volume was used. The outer phase was composed of 600 μl of 0.1 wt % azobenzene surfactant and 80 μl of 2 wt % Zonyl FS-300 in water. A laser-printed photomask transparency displaying a smiley or the MIT logo was placed beneath the droplets in a dish on the stage of an inverted microscope. In the case of the MIT logo, a piece of semi-transparent Scotch table was placed over the “i” to partially block light transmission to the sample and to induce a grey-scaling effect. The sample of liquid lenses, initially in a Janus morphology, was then illuminated with UV light through the photomask (DAPI filter, λ=365 nm) to induce transformation of the droplets in the exposed areas to the double emulsion state. This light-induced reconfiguration of the lens-internal interface can be reversed by exposure to blue light (through a FITC filter, λ=470±20 nm). Gelatin can be added to the outer aqueous phase to reduce the rate of diffusion and prolong image persistency.

### Optical Simulations

In all simulations, the overall droplet shape was assumed to be spherical, (assuming that the interfacial tensions γ_{FH} between fluorocarbon and hydrocarbon, γ_{F} between fluorocarbon and the aqueous medium, and γ_{H} between hydrocarbon and the aqueous medium, satisfy the relations γ_{FH}<<γ_{F}≈γ_{H}). The internal interfaces were assumed to be spherical because, for example, interfaces between liquids can be considered to be spherical when the ratio of gravitational forces to surface tension forces is small. This ratio may be given by the Bond number

$$Bo = \frac{Δ ρ \cdot g \cdot {L}^{2}}{{γ}_{FH}} ,$$

where Δρ is the difference in density of the two droplet phases, g the gravitational constant, and L the droplet diameter⁵⁷. For a material system similar to the one used here, such as the hexane-perfluorohexane bi-phase droplets with a diameter of 100 μm, constituent densities of

$${ρ}_{HX} = 0.66 \frac{g}{{cm}^{2}} and {ρ}_{FHX} = 1.68 \frac{g}{{cm}^{2}} ,$$

and a surface tension

$${γ}_{FH} = 0.4 \frac{mN}{m} ,$$

the Bond number is around 0.25. While a Bond number of around 0.1 is usually considered to be an upper limit for assuming spherical curvature of a liquid-liquid interface, images of these complex droplets show that the interface of the droplets obtained can be approximated reasonably well with a spherical fit (inset in FIG. 5E). Deviations are apparent closer to the triple-phase contact line, but these regions do not strongly affect the optical behavior of the droplet lenses.

Finite difference time domain simulations were completed using the open source software package MIT Electromagnetic Equation Propagation (MEEP). Double emulsions and Janus droplets of Heptane (n_{H}=1.387) and FC-770 (n_{F}=1.27) with a radius of 5 μm in water (n_{W}=1.33) were illuminated with a 500 nm wavelength monochromatic line light source. Equal volumes of Heptane and FC-770 were simulated, and the overall droplet shape and the shape of the interface were assumed to be spherical, such that Eq. 1 yields the interface location. A perfectly matched layer (PML) was used as the boundary condition on all edges of the cell, and the resolution was 32 units per μm. The simulation was run until a steady state was reached where the intensity no longer varied between time steps.

Ray-tracing was implemented in MATLAB. Each ray was defined by its location, direction, intensity, and polarization. The rays were propagated to the drop and were refracted and reflected at each interface of the drop. The direction vector \vec{d}ₜ of the refracted ray was determined using a vector version of Snell's law:

$${\vec{d}}_{t} = \frac{{n}_{1}}{{n}_{2}} {\vec{d}}_{i} + ( \frac{{n}_{1}}{{n}_{2}} cos ( {θ}_{i} ) - \sqrt{1 - {( \frac{{n}_{1}}{{n}_{2}} )}^{2} [ 1 - {cos}^{2} ( {θ}_{i} ) ]} ) \vec{n} \qquad ( 6 )$$

where \vec{d}ᵢ is the direction of the incident ray, \vec{n} is the surface normal, θᵢ is the angle that the incoming ray makes with the surface normal, and n₁ and n₂ are the refractive indices before and after the interface. The intensity of the refracted and reflected rays were calculated using the Fresnel Equations⁴⁶.
The ray transfer matrix was calculated numerically using MATLAB. The transfer matrix consisted of the product of transfer matrixes for a ray entering the drop (water to heptane), propagating a distance R_{d}+l to the interface between heptane and FC-770, being refracted at this interface, propagating the rest of the way through the drop, and being refracted at the outer interface of the drop (FC-770 to water). In order to compare with experiments, refraction through the coverslip after the drop was included in the ray transfer matrix. The locations of the focal points were consistent between the ray transfer matrix and ray-tracing.

The morphology of the droplet with heptane as the internal phase is determined by the surface tensions of the various liquids and the volume ratio

$${v}_{r} = \frac{{v}_{H}}{{v}_{F}} ,$$

where V_{H} is the volume of heptane and V_{F} the volume of FC-770. If the overall droplet is considered to be spherical, then the volume of heptane is:

$${v}_{H} = \frac{{v}_{r}}{1 + {v}_{r}} {V}_{drop} = \frac{{v}_{r}}{1 + {v}_{r}} \frac{4}{3} π {R}_{d}^{3} , \qquad ( 7 )$$

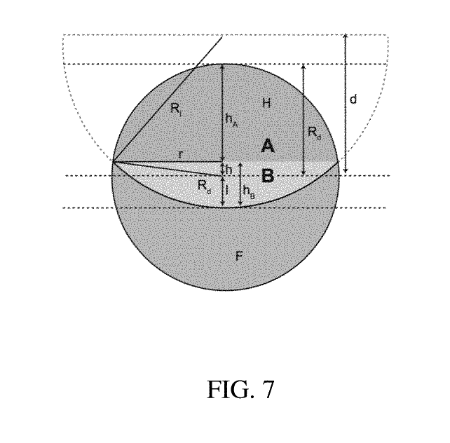

with R_{d} being the droplet radius (FIG. 7). The location of the interface was determined from the internal curvature Rᵢ, by noting that the volume of heptane is equal to the volume of region A plus the volume of region B, each of which can be obtained by calculating the volumes of the spherical caps:

$${V}_{H} = {V}_{A} + {V}_{B} = \frac{π}{3} {h}_{A}^{2} ( 3 {R}_{d} - {h}_{A} ) + \frac{π}{3} {h}_{B}^{2} ( 3 {R}_{i} - {h}_{B} ) \qquad ( 8 )$$

The height of the spherical caps was determined by the distance from the center of the droplet to the plane of the three-phase contact line h, such that:

h_{A}=R_{d}−h and h_{B}=l+h. (9)

The location of the three-phase contact line is the intersection of the sphere forming the internal interface with the sphere that defines the overall droplet. In other words,

r²+h²=R_{d}² and r²+(d−h)²=Rᵢ², (10)

where d is the distance from the center of the droplet to the center of the sphere that defines the internal interface.
Combining Eqs. 7-9 and eliminating r, h, h_{A}, h_{B}, and d, yields Eq. 1.
In the limit that γ_{FH}<<γ_{R}≈γ_{H}, it has been shown that the contact angles at the three phase contact line are

$$\frac{{γ}_{H} - {γ}_{F}}{{γ}_{HF}} = cos ( {θ}_{F} ) = - cos ( {θ}_{H} ) , \qquad ( 11 )$$

which by applying the law of cosines yields Eq. 2.
Determination of the Focal Length from the Image-Object Locations

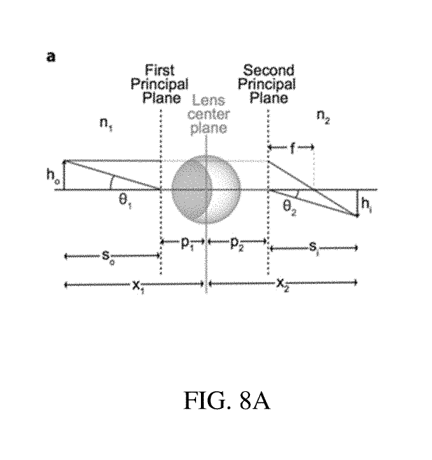

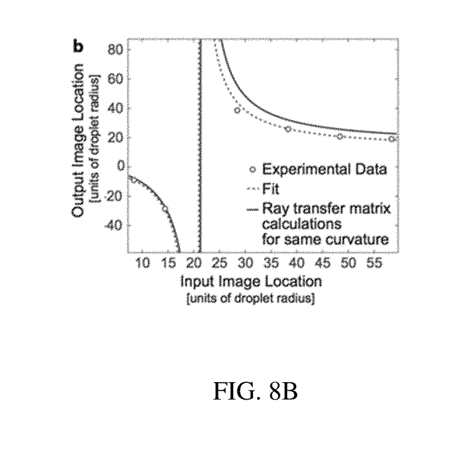

In order to determine the droplets' focal length, a pattern was projected in front of the droplets and used as the “object”. The image formed by the drops (the “image”) was recorded. By varying the location of the object, the image location can be varied, allowing us to determine the focal length of the drops. A common form of the standard thick lens equation was used to find the focal length, accounting for the fact that the droplet-coverslip system formed a boundary between two different refractive index media, as shown in FIG. 8A.

Consider an object of height hₒ located at a distance x₁ from the center of the droplet. For a thick lens system, all refraction can be considered to happen at the principal planes, such that a ray passing through the optical axis at the first principal plane (red ray in FIG. 8A) will be refracted according to Snell's law, which in the paraxial approximation is given by:

n₁θ₁=n₂θ₂,

with n₁ n₂ and θ₁, θ₂ being the refractive indices and angles of the incident and refracted rays with the interface normal for medium 1 and 2, respectively. This can also be written in terms of the object and image heights hₒ, hᵢ, the distance of the object to the first principal plane sₒ, and the distance of the image to the second principal plane sᵢ:

$${n}_{1} \frac{{h}_{o}}{{z}_{o}} = {n}_{2} \frac{- {h}_{i}}{{s}_{i}} . \qquad ( 12 )$$

A ray that hits the first principal plane parallel to the optical axis will be refracted at the second principal plane and pass through the back focal point, which gives

$$\frac{{h}_{o}}{f} = - \frac{{h}_{i}}{{s}_{i} - f} , \qquad ( 13 )$$

with f being the focal length measured in the second medium. Combining Eqs. 12 and 13 yields a modified version of the lens equation:

$$\frac{{n}_{1}}{{n}_{2}} \frac{1}{{s}_{o}} + \frac{1}{{s}_{i}} = \frac{1}{f} .$$

In terms of the measured distances from the center of the droplet, this yields:

$$\frac{{n}_{2}}{{n}_{2}} \frac{1}{{x}_{1} - {p}_{1}} + \frac{1}{{x}_{2} - {p}_{2}} = \frac{1}{f} , \qquad ( 14 )$$

where p₁ and p₂ are the distances from the droplet center to the first and second principal planes, which were used as fitting parameters when determining the focal length of the droplets, as shown in FIG. 8B.

### Correction to Interface Shape Due to Refraction at Droplet Interface

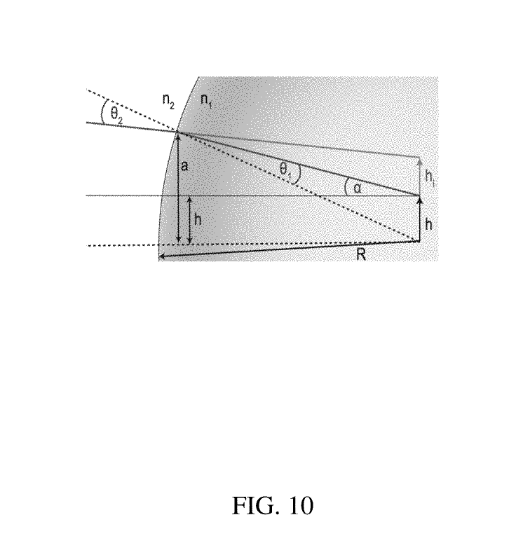

When the interface between the two liquids is imaged through the outer phase of the droplet, the image of the interface may be magnified. In order to correct for the magnification, the paraxial approximation was used. Consider an object of height h located inside of a sphere of radius R and refractive index n₁, which is positioned inside a medium of refractive index n₂, as shown in FIG. 10. A ray leaving the object at an angle α may hit the interface of the drop at a height a=h Rα (under the assumption α<<1). At this height, the surface normal is at an angle

$$\frac{a}{R} = \frac{h}{R} + α ,$$

such that the ray hits the surface at an angle

$${θ}_{1} = \frac{h}{R} + α - α = \frac{h}{R} \qquad ( 15 )$$

for all rays with α<<1. Each ray is refracted according to Snell's law:

$${θ}_{2} = \frac{{n}_{1}}{{n}_{2}} {θ}_{1} = \frac{{n}_{2}}{{n}_{2}} \frac{h}{R} \qquad ( 16 )$$

Similarly, the height were all the rays converge (the image is formed) is given by:

$${h}_{1} = R {θ}_{2} = \frac{{n}_{1}}{{n}_{2}} h . \qquad ( 17 )$$

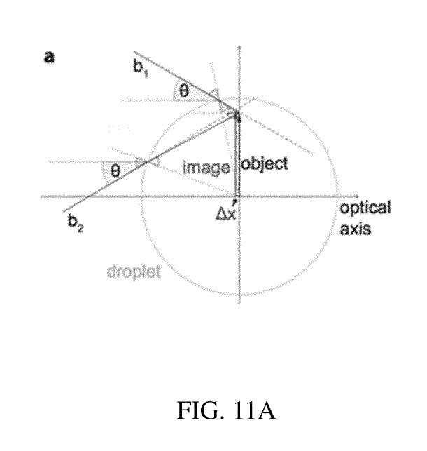

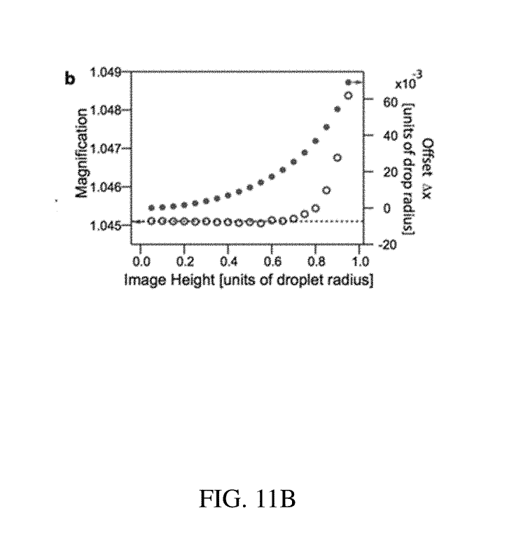

Snell's law was used in the free software package Geogebra to determine the image height of an object located inside a droplet of refractive index n₁=1.39 (heptane) in a medium of refractive index n₂=1.33 (water). FIGS. 11A-11B shows how the magnification depends on image height. For a small object, the magnification matches that of the paraxial approximation, but diverges for larger objects. For an object of 0.9 times the radius of the droplet, the error resulting from the paraxial approximation was less than 0.3%, which is significantly smaller than the uncertainty in the location of the interface (line thickness) in the images.

### Vector Form of Snell's Law for Ray Tracing

The ray tracer that was implemented in MATLAB uses Snell's Law in vector form in order to unambiguously determine the direction of each ray after it was refracted through a surface. Consider a ray traveling along a vector [symbol] ₁ refracting through a surface with normal [symbol] . The incidence angle θ₁ is given by the angle between the propagation vector [symbol] ₁ and the surface normal [symbol] . The vector [symbol] ₁ of the incident light can be broken down into components tangential ( [symbol] ) and normal ( [symbol] ) to the surface:

[symbol]

₁=sin(θ₁) [symbol] +cos(θ₁) [symbol] (18)

Similarly the propagation vector [symbol] ₂ of the outgoing ray can be written as

[symbol]

₂=sin(θ₂) [symbol] +cos(θ₂) [symbol] (19)

where θ₂ is the angle between [symbol] ₂ and [symbol] .
The tangential vector [symbol] can be determined from Eq. 18:

$$\vec{t} = \frac{{\vec{d}}_{1} - cos ( {θ}_{1} ) \vec{n}}{sin ( {θ}_{1} )} \qquad ( 20 )$$

The outgoing angle θ₂ can be determined from Snell's law:

n₁ sin(θ₁)=n₂ sin(θ₂). (21)

Using the trigonometric identity sin² θ+cos² θ=1 Snell's Law can be written as

$${cos}^{2} ( {θ}_{2} ) = \sqrt{1 - {( \frac{{n}_{1}}{{n}_{2}} )}^{2} [ 1 - {cos}^{2} ( {θ}_{1} ) ]} \qquad ( 22 )$$

Substituting Eqs. 20-22 into Eq. 19 yields the vector form of Snell's law

$$\vec{{d}_{2}} = \frac{{n}_{1}}{{n}_{2}} {\vec{d}}_{1} + ( \frac{{n}_{1}}{{n}_{2}} cos ( {θ}_{1} ) - \sqrt{1 - {( \frac{{n}_{1}}{{n}_{2}} )}^{2} [ 1 - {cos}^{2} ( {θ}_{1} ) ]} ) \vec{n}$$

### Droplet Stability

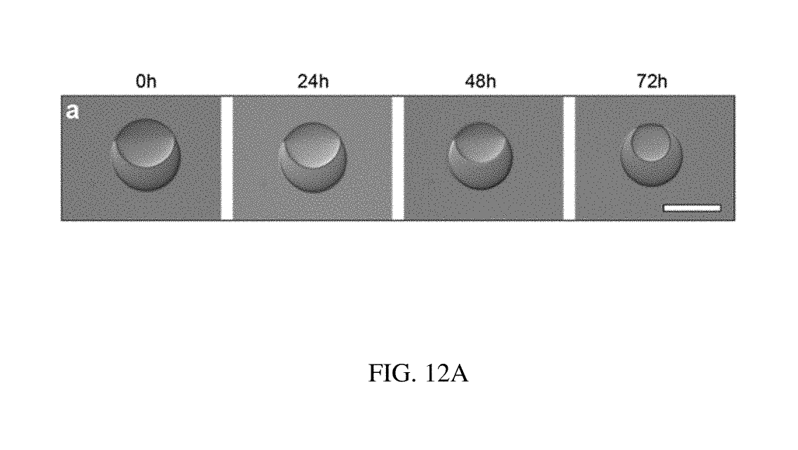

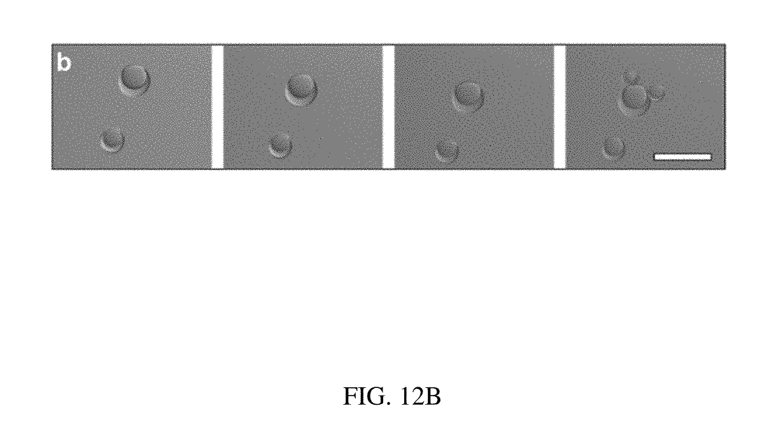

The solubility of hexane, heptane, and FC770 is generally extremely low in water; however, over sufficiently long time scales, diffusion of hexane or heptane through the aqueous medium into the ambient environment can lead to changes in droplet morphology. This may be prevented by keeping the droplets and the medium in a closed environment and by suppressing diffusion into the aqueous medium, which can be achieved through priming with the respective solvent. FC770, a long-chain fluorinated oil, was not found to diffuse into the aqueous medium on the timescale of days. FIG. 12A visualizes droplet morphology variation in suboptimal experiment condition, while FIGS. 12A-12B shows that the droplets are stable, if the experimental conditions are appropriately controlled. For the heptane-FC770 droplets shown in the figure, the sample chamber was sealed to prevent any exchanges with the ambient environment and saturate the aqueous medium with heptane, to avoid heptane diffusion from the droplets into the medium.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. An article, comprising:
a plurality of droplets dispersed within an outer phase, wherein:
the plurality of droplets comprise a first component and a second component immiscible with the first component under a particular set of conditions,
at least a first portion of the plurality of droplets has a first average focal length for transmitted or reflected light, and
at least a second portion of the plurality of droplets has a second average focal length for transmitted or reflected light, different than the first average focal length.

2. An article, comprising:
a plurality of droplets dispersed within an outer phase, wherein:
the plurality of droplets comprise a first component and a second component immiscible with the first component under a particular set of conditions,
at least a first portion of the plurality of droplets has a first radius of curvature between the first component and the second component that causes light rays to focus, and
at least a second portion of the plurality of droplets has a second radius of curvature between the first component and the second component that causes light rays to focus, different than the first radius of curvature.

3. An article, comprising:
a plurality of droplets dispersed within an outer phase, wherein:
the plurality of droplets comprise a first component and a second component immiscible with the first component under a first set of conditions,
the plurality of droplets have a first average focal length for transmitted or reflected light under the first set of conditions, and
the plurality of droplets have a second average focal length for transmitted or reflected light different than the first average focal length under a second set of conditions, different than the first set of conditions.

4. An article, comprising:
a plurality of droplets dispersed within an outer phase, wherein:
the plurality of droplets comprise a first component and a second component immiscible with the first component under a first set of conditions,
the plurality of droplets have a first average radius of curvature between the first component and the second component that causes light rays to focus under the first set of conditions, and
the plurality of droplets have a second average radius of curvature between the first component and the second component that causes light rays to focus under a second set of conditions, different than the first set of conditions.

5. An article as in any preceding claim, wherein the first set of conditions comprises a condition selected from the group consisting of heat, cold, light, mechanical force, electromagnetic radiation, ionizing radiation, a magnetic field, an electric field, an analyte, and combinations thereof.

6. An article as in any preceding claim, wherein the second set of conditions comprises a condition selected from the group consisting of heat, cold, light, mechanical force, electromagnetic radiation, ionizing radiation, a magnetic field, an electric field, an analyte, and combinations thereof, and different than the first set of conditions.

7. An article as in any preceding claim, wherein the outer phase is an aqueous phase.

8. An article as in any preceding claim, wherein the outer phase is a non-aqueous phase.

9. An article as in any preceding claim, wherein the outer phase is a polymer.

10. An article as in any preceding claim, wherein the outer phase is an elastomer.

11. An article as in any preceding claim, wherein the outer phase is a glass.

12. An article as in any preceding claim, wherein at least one of the components comprising the droplet contain a hydrocarbon, fluorocarbon, liquid crystal, ionic liquid or polymer solution.

13. An article as in any preceding claim, wherein at least 10% of the plurality of droplets are in physical contact with each other.

14. An article as in any preceding claim, wherein at least 10% of the plurality of droplets are organized in a regular two dimensional array.

15. An article as in any preceding claim, wherein at least 10% of the plurality of droplets are organized in a regular three-dimensional array.

16. A device, comprising an article as in any preceding claim and a substrate adjacent the article.

17. A device as in claim 16, wherein the device is an optical imaging system, a miniaturized optical imaging system, a miniaturized tomographic imaging system for 3D image acquisition, a miniaturized integral imaging device, an optical image projecting system, and/or an auto-stereoscopic display.

18. A method, comprising:
providing a plurality of droplets dispersed within an outer phase, wherein the plurality of droplets have a first average radius of curvature between a first component and a second component within the droplets; and
stimulating the plurality of droplets such that at least a portion of the plurality of droplets has a second average radius of curvature between the first component and the second component, different than the first average radius of curvature.

19. The method of claim 18, wherein stimulating the plurality of droplets comprises exposing at least a portion of the plurality of droplets to electromagnetic radiation, ionizing radiation, a magnetic field, an electric field, a mechanical force, adjusting the ionic strength of the outer phase, adjusting the temperature of the outer phase, exposing the plurality of droplets to photochemical stimulation, adding an analyte to the outer phase, or combinations thereof.
